(19) United States
(12) Patent Application Publication
(10) Pub. No.: US 2025/0016020 A1
(43) Pub. Date: Jan. 9, 2025

(54) HOME APPLIANCE OPERATING BASED ON USER DETECTION RESULT AND HOME APPLIANCE CONTROL METHOD

(71) Applicant: Samsung Electronics Co., Ltd., Suwon-si (KR)

(72) Inventors: Juhyeon PAENG, Suwon-si (KR); Yesol LEE, Suwon-si (KR); Kyungjae KIM, Suwon-si (KR); Hyelim PARK, Suwon-si (KR); Soohyun SUNG, Suwon-si (KR); Byeongcheol YOON, Suwon-si (KR); Myoungsoo JANG, Suwon-si (KR); Chihong CHO, Suwon-si (KR)

(21) Appl. No.: 18/750,572

(22) Filed: Jun. 21, 2024

Related U.S. Application Data
(63) Continuation of application No. PCT/KR2024/007847, filed on Jun. 10, 2024.

(30) Foreign Application Priority Data
Jul. 4, 2023 (KR) 10-2023-0086774
Sep. 13, 2023 (KR) 10-2023-0122064

(51) Int. Cl. H04L 12/28

(52) U.S. Cl. CPC H04L 12/282

(57) ABSTRACT

A home appliance control method is provided. The home appliance control method includes, when a user is detected in a first space among a plurality of spaces within a home, determining whether the user is using the first space, based on a first usage time for which the user stays in the first space, when it is determined that the detected user is using the first space, determining a second space predicted to be used next by the user among the plurality of spaces within the home, based on user routine information including a spatial movement prediction path of the user predicted in advance for the plurality of spaces within the home, and controlling an operation of at least one home appliance of the second space.

### CROSS-REFERENCE TO RELATED APPLICATION(S)

This application is a continuation application, claiming priority under § 365(c), of an International application No. PCT/KR2024/007847, filed on Jun. 10, 2024, which is based on and claims the benefit of a Korean patent application number 10-2023-0086774, filed on Jul. 4, 2023, in the Korean Intellectual Property Office, and of a Korean patent application number 10-2023-0122064, filed on Sep. 13, 2023, in the Korean Intellectual Property Office, the disclosure of each of which is incorporated by reference herein in its entirety.

### TECHNICAL FIELD

The disclosure relates to a home appliance, a home appliance control method, and a computer-readable recording medium having recorded thereon a program for causing a computer to perform the home appliance control method.

### BACKGROUND ART

Recently, as various types of home appliances have become widespread in the home, various home appliances are arranged in a plurality of spaces within the home. Home appliances arranged in a plurality of spaces within the home control the temperature, air, lighting, and visual/auditory background of each space, or provide various functions, such as food cooking, clothing care, or shoe care. When a user uses home appliances while moving between various spaces within the home, the user needs to separately operate the home appliances in each space. However, separately operating the home appliances in each space causes inconvenience to users.

The above information is presented as background information only to assist with an understanding of the disclosure. No determination has been made, and no assertion is made, as to whether any of the above might be applicable as prior art with regard to the disclosure.

### DESCRIPTION OF EMBODIMENTS

### Technical Solution to Problem

Aspects of the disclosure are to address at least the above-mentioned problems and/or disadvantages and to provide at least the advantages described below. Accordingly, an aspect of the disclosure is to provide a home appliance, a home appliance control method, and a computer-readable recording medium having recorded thereon a program for causing a computer to perform the home appliance control method.

Additional aspects will be set forth in part in the description which follows and, in part, will be apparent from the description, or may be learned by practice of the presented embodiments.

### Technical Solution

In accordance with an aspect of the disclosure, a home appliance control method is provided. The home appliance control method includes, when a user is detected in a first space among a plurality of spaces within a home, determining whether the user is using the first space, based on a first usage time for which the user stays in the first space, when it is determined that the detected user is using the first space, determining a second space predicted to be used next by the user among the plurality of spaces within the home, based on user routine information including a spatial movement prediction path of the user predicted in advance for the plurality of spaces within the home, and controlling an operation of at least one home appliance of the second space.

In accordance with another aspect of the disclosure, a home appliance is provided. The home appliance includes communication module configured to communicate with at least one home appliance arranged in a plurality of spaces within a home, a detection sensor configured to detect a user in a space within the home, memory storing at least one instruction, and at least one processor, wherein the at least one processor is configured to execute the at least one instruction to, when a user is detected in a first space among the plurality of spaces within the home by using a sensor detection value of the detection sensor, determine whether the user is using the first space, based on a first usage time for which the user stays in the first space, when it is determined that the detected user is using the first space, determine a second space predicted to be used next by the user among the plurality of spaces within the home, based on user routine information including a spatial movement prediction path of the user predicted in advance for the plurality of spaces within the home, and control an operation of at least one home appliance of the second space.

In accordance with another aspect of the disclosure, a non-transitory computer-readable recording medium storing one or more programs including computer-executable instructions that, when executed by one or more processors of home appliance individually or collectively, cause the home appliance to perform operations, the operations are provided. The operations include when a user is detected in a first space among a plurality of spaces within a home, determining whether the user is using the first space, based on a first usage time for which the user stays in the first space, when it is determined that the detected user is using the first space, determining a second space predicted to be used next by the user among the plurality of spaces within the home, based on user routine information including a spatial movement prediction path of the user predicted in advance for the plurality of spaces within the home, and controlling an operation of at least one home appliance of the second space.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating an operation of a home appliance according to an embodiment of the disclosure;

FIG. 2 is a block diagram illustrating a configuration of a home appliance according to an embodiment of the disclosure;

FIG. 3 is a flowchart of a home appliance control method according to an embodiment of the disclosure;

FIG. 4 is a diagram illustrating a home appliance, an external device, and a server according to an embodiment of the disclosure;

FIG. 5 is a flowchart of a process in which a server, a first home appliance, and a second home appliance perform a home appliance control method, according to an embodiment of the disclosure;

FIG. 6 is a diagram illustrating a process in which a plurality of home appliances operate while communicating with each other, according to an embodiment of the disclosure;

FIG. 7 is a diagram illustrating user routine information according to an embodiment of the disclosure;

FIG. 8 is a diagram illustrating a process of learning user routine information by using a machine learning model, according to an embodiment of the disclosure;

FIG. 9 is a diagram illustrating a process of generating user routine information from a machine learning model, according to an embodiment of the disclosure;

FIG. 10 is a diagram illustrating a process of determining user routine information from a plurality of pieces of candidate user routine information according to additional information, according to an embodiment of the disclosure;

FIG. 11 is a diagram illustrating a process of generating a plurality of pieces of candidate user routine information by using a machine learning model, according to an embodiment of the disclosure;

FIG. 12 is a diagram illustrating a process of generating user routine information from a machine learning model, according to an embodiment of the disclosure;

FIG. 13 is a diagram illustrating a process of receiving user routine information from a user, according to an embodiment of the disclosure;

FIG. 14 is a diagram illustrating a process in which a home appliance is operated based on a wake-up event of a user, according to an embodiment of the disclosure;

FIG. 15 is a diagram illustrating a process in which a home appliance is operated based on a wake-up event, according to an embodiment of the disclosure;

FIG. 16 is a diagram illustrating a process of terminating a spatial movement prediction operation according to a movement path of a user, according to an embodiment of the disclosure;

FIG. 17 is a diagram illustrating a process of identifying a user and determining user routine information for the identified user, according to an embodiment of the disclosure;

FIG. 18 is a diagram illustrating controlling home appliances in a second space, according to an embodiment of the disclosure;

FIG. 19 is a diagram illustrating controlling home appliances in a second space, according to an embodiment of the disclosure;

FIG. 20 is a diagram illustrating controlling home appliances in a second space, according to an embodiment of the disclosure;

FIG. 21 is a diagram illustrating an operation when a user's usage time of a given space exceeds a usage prediction time, according to an embodiment of the disclosure;

FIG. 22 is a diagram illustrating a process of temporarily reducing the usage prediction time in user routine information when a delay occurs in a user routine, according to an embodiment of the disclosure;

FIG. 23 is a diagram illustrating a process of omitting some space from user routine information when a delay occurs in a user routine, according to an embodiment of the disclosure; and

FIG. 24 is a diagram illustrating a structure of a home appliance according to an embodiment of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly indicates otherwise. Thus, for example, reference to “a component surface” includes reference to one or more of such surfaces.

In the disclosure, the expressions “A or B,” “at least one of A and B,” “at least one of A or B,” “A, B, or C,” “at least one of A, B, and C,” and “at least one of A, B, or C” may include any one of the items listed in the corresponding expression or all possible combinations thereof.

The term “and/or” as used herein includes a combination of a plurality of related recited elements or any one of a plurality of related recited elements.

The terms “first,” “second,” etc. as used herein may be only used to distinguish one element from another and do not limit the elements in any other aspects (e.g., importance or order).

When a certain (e.g., first) element is referred to as being “coupled” or “connected” to another (e.g., second) element with or without the terms “functionally” or “communicatively,” it means that the certain element may be coupled or connected to the other element directly (e.g., by wire) or wirelessly or through a third element.

The terms “comprise” or “include” as used herein are inclusive and therefore specify the presence of stated features, integers, steps, operations, elements, components, or combinations thereof, but do not preclude the presence or addition of one or more other features, integers, steps, operations, elements, components, or combinations thereof.

It will be understood that when an element is referred to as being “connected to,” “coupled to,” “supported to,” or “in contact with” another element, the element may be “directly connected to, coupled to, supported to, or in contact with” the other element or may be “indirectly connected to, coupled to, supported to, or in contact with” the other element through a third element.

It will be understood that when an element is referred to as being located “on” another element, the element may be in contact with the other element, and another element may also be present between the two elements.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

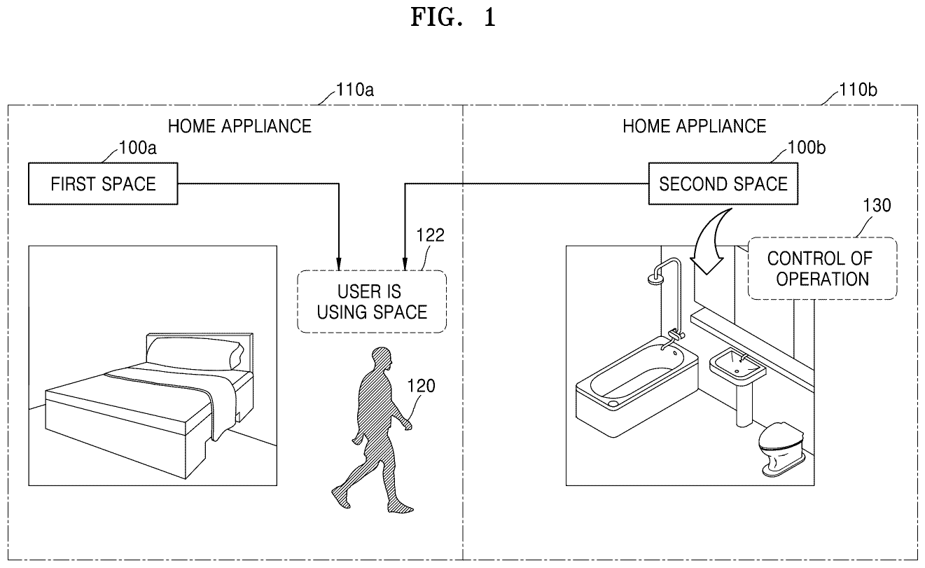

FIG. 1 is a diagram illustrating an operation of a home appliance according to an embodiment of the disclosure.

According to an embodiment of the disclosure, referring to FIG. 1, a server or at least one home appliance 100a and 100b may control the home appliances 100a and 100b arranged in a plurality of spaces 110a and 110b within the home by using a spatial movement prediction path of a user 120. The home appliances 100a and 100b according to an embodiment of the disclosure, may be arranged in the spaces 110a and 110b within the home. A case where the first home appliance 100a is arranged in the first space 110a within the home and the second home appliance 100a is arranged in the second space 110b within the home is described as an example in FIG. 1. In addition, a home appliance control operation according to an embodiment of the disclosure may be performed by the server or the at least one home appliance 100a and 100b arranged in the home. The following description is given focusing on an embodiment of the disclosure in which a home appliance control method is performed by the server. However, the at least one home appliance 100a and 100b arranged in the home may also act as a server to control the home appliances 100a and 100b arranged in the home. Therefore, embodiments of the disclosure may be applied to both the embodiment performed by the server and the embodiment performed by the at least one home appliance 100a and 100b.

The server or the at least one home appliance 100a and 100b detects the user 120 in the spaces 110a and 110b within the home. When the server or the at least one home appliance 100a and 100b detects the user 120 in one of the spaces 110a and 110b, the server or the at least one home appliance 100a and 100b determines whether the user 120 is using the space by using the time for which the user 120 stays in the detected space. When the server or the at least one home appliance 100a and 100b determines that the user 120 is using the space 122, the server or the at least one home appliance 100a and 100b determines a space predicted to be used next by the user 120, based on user routine information including a path along which the user 120 is predicted to move in the spaces 110a and 110b within the home. For example, when the server or the at least one home appliance 100a and 100b detects the user 120 in the first space 110a and determines that the user 120 is using the first space 110a, the server or the at least one home appliance 100a and 100b determines that the user 120 will use the second space 110b next, based on the user routine information.

The server or the at least one home appliance 100a and 100b controls the operation of the second home appliance 100b of the second space 110b at block 130. For example, the server or the at least one home appliance 100a and 100b starts the operation of the second home appliance 100b before the user 120 moves to the second space 110b, so that the user 120 is allowed to use the second home appliance 100b without any special manipulation. In addition, for example, the server or the at least one home appliance 100a and 100b starts the operation of the second home appliance 100b before the user 120 moves to the second space 110b, so that the user 120 is allowed to use the second home appliance 100b without any delay due to a preparation operation of the second home appliance 100b.

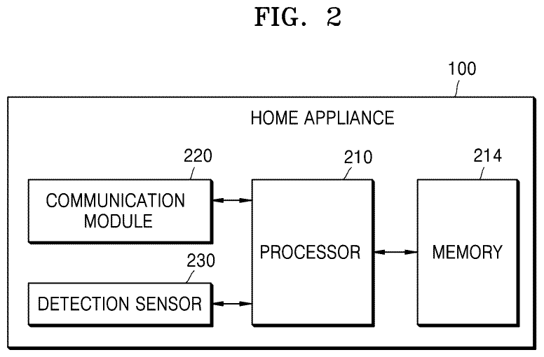

FIG. 2 is a block diagram illustrating a configuration of a home appliance according to an embodiment of the disclosure.

Referring to FIG. 2, a home appliance 100 according to an embodiment of the disclosure may be implemented as various types of home appliances. The home appliance 100 may include, for example, at least one of an air conditioner, an air conditioner, a heater, an air purifier, a ventilation fan, a hot water generator, a cooking appliance, an oven, an induction stove, a cooker, a microwave oven, a clothing care device, a shoe care device, a lighting device, a bidet, a wireless vacuum cleaner, a robot vacuum cleaner, a television, a refrigerator, an audio system, a washing machine, a set-top box, a home automation control panel, or a security control panel.

The home appliance 100 may be arranged in a plurality of spaces within the home. The spaces within the home refer to spaces separated by walls or doors. The spaces may include, for example, a bedroom, a bathroom, a living room, a kitchen, a dressing room, a study, a balcony, a laundry room, an entrance, a pantry, or a hallway. The types and regions of the spaces within the home may be predefined in the server or the at least one home appliance 100. The spaces within the home may be defined in various ways. For example, the spaces within the home may be predefined based on the floor plan of the relevant living space, may be defined by the spatial recognition results of mobile home appliances such as robot vacuum cleaners, or may be defined based on user input.

Various combinations of home appliances 100 may be arranged in each space. For example, an air conditioner, an air purifier, and a television may be arranged in a bedroom, a heater, a ventilation fan, a hot water generator, and a bidet may be arranged in a bathroom, an induction stove, an oven, and a refrigerator may be arranged in a kitchen, and a clothing care device may be arranged in a dressing room. The home appliance 100 to be controlled according to an embodiment of the disclosure may be designated in advance from among at least one home appliance 100 arranged in each space. For example, among the air conditioner, the air purifier, and the television in the bedroom, the air conditioner and the air purifier may be subject to automatic control according to the result of spatial movement prediction for the user 120, and the television may be excluded from subject to automatic control.

The home appliance 100 may include a processor 210, memory 214, a communication module 220, and a detection sensor 230.

The processor 210 controls overall operations of the home appliance 100. The processor 210 may be implemented as one or more processors. The processor 210 may perform a certain operation by executing instructions or commands stored in the memory 214. In addition, the processor 210 controls the operations of elements provided in the home appliance 100. The processor 210 may include a central processing unit (CPU), a microprocessor, or the like.

The memory 214 may store a variety of information, data, instructions, programs, and the like, which are necessary for the operation of the home appliance 100. The memory 214 may include at least one of volatile memory or non-volatile memory, or a combination thereof. The memory 214 may include, for example, at least one type of storage medium selected from among flash memory-type memory, hard disk-type memory, multimedia card micro-type memory, card-type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, magnetic disc, and optical disc. In addition, the memory 214 may correspond to a web storage or a cloud server that performs a storage function on the Internet.

The communication module 220 may communicate with a server or an external device via a network. For example, the communication module 220 may perform short-range wireless communication with other home appliances 100. The communication module 220 may connect to the network through an access point and perform communication with a server.

The communication module 220 may include a wireless communication module (e.g., a cellular communication module, a short-range wireless communication module, or a global navigation satellite system (GNSS) communication module) or a wired communication module (e.g., a local area network (LAN) communication module or a power line communication module). In addition, the communication module 220 may perform short-range wireless communication and may use, for example, Bluetooth, Bluetooth Low Energy (BLE), near field communication (NFC), wireless local area network (WLAN) (Wi-Fi™), Zigbee, Infrared Data Association (IrDA) communication, Wi-Fi Direct (WFD), Ultra-Wideband (UWB), Ant+ communication, etc. Furthermore, for example, the communication module 220 may perform long-range communication and may communicate with, for example, an external device via a legacy cellular network, a 5th generation (5G) network, a next-generation communications network, the Internet, or a computer network (e.g., a local area network (LAN) or a wide area network (WAN)).

Moreover, the communication module 220 may use mobile communication and may transmit and receive wireless signals to and from at least one of a base station, an external terminal, or a server on a mobile communication network.

According to an embodiment of the disclosure, the communication module 220 may be connected to an access point within the home through Wi-Fi™ communication. The communication module 220 may communicate with an external device through an access point.

The detection sensor 230 may detect an object in a target space. The target space is a space in which the home appliance 100 is arranged and may correspond to the first space 110a or the second space 110b. The detection sensor 230 may include, for example, a time of flight (ToF) sensor, an ultrasonic sensor, an infrared sensor, an optical sensor, a radio detection and ranging (RADAR) sensor, or a light detection and ranging (LiDAR) sensor. The detection sensor 230 is arranged to output a signal to the target space and detect a reflection signal. The detection sensor 230 may be arranged on the front of the home appliance 100 toward the target space.

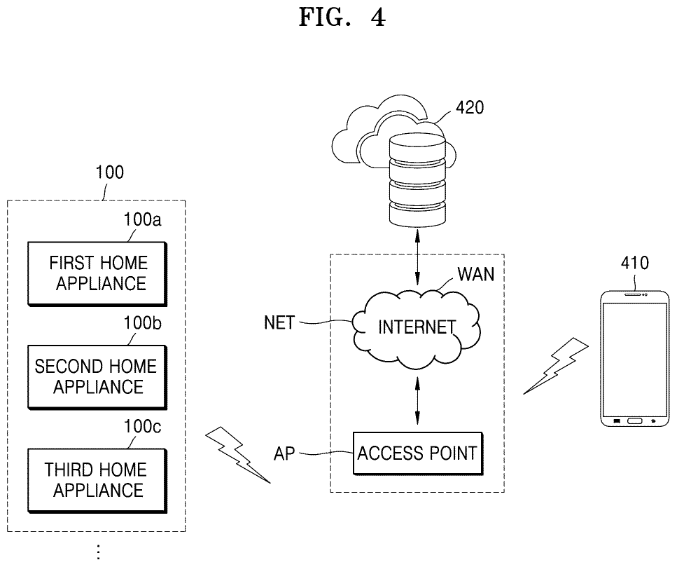

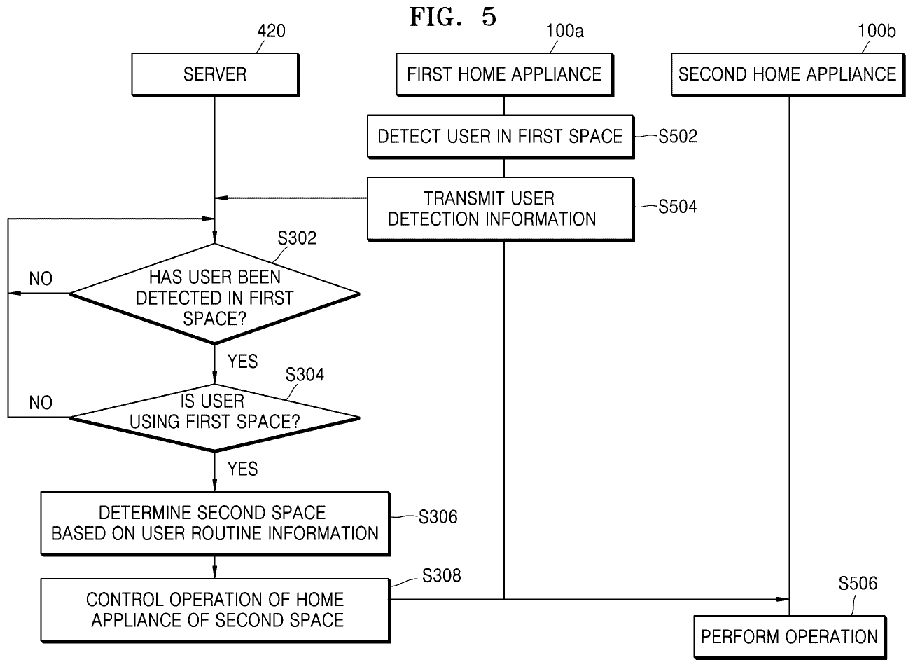

Hereinafter, the description of FIG. 2 is given focusing on an embodiment of the disclosure in which the home appliance 100 itself determines whether the user is using the first space, determines the second space predicted to be used next by the user, and controls the operation of at least one home appliance of the second space. However, according to an embodiment of the disclosure, the server may determine whether the user is using the first space, determine the second space predicted to be used next by the user, and control the operation of at least one home appliance of the second space. An embodiment of the disclosure in which the server controls the operation of the home appliance of the second space is described in detail below with reference to FIGS. 4 and 5.

The processor 210 uses a sensor detection value of the detection sensor 230 to determine whether a sensor detection value corresponding to a person has been detected and whether there is a moving object. When the sensor detection value corresponding to the person is detected and there is the moving object, the processor 210 determines that there is a person in the target space. According to an embodiment of the disclosure, the processor 210 may determine whether the object detected based on the sensor detection value is a person. For example, in a case where the detection sensor 230 corresponds to an infrared sensor, when an infrared value corresponding to a person is detected, the processor 210 determines that a person exists in the target space. In addition, according to an embodiment of the disclosure, the processor 210 determines whether the object detected based on the sensor detection value is in the shape of a person. When the detected object corresponds to the shape of a person, the processor 210 determines that a person exists in the target space.

The processor 210 may determine the space in which the person has been detected by using information about the space in which the home appliance 100 having detected the person is arranged. For example, when a plurality of home appliances 100 are arranged in a plurality of spaces in the home and the processor 210 determines that a person has been detected from a sensor detection value of a detection sensor 230 of an air conditioner among the home appliances 100, the processor 210 determines that the person has been detected in a space (e.g., a bedroom) in which the air conditioner is arranged. The information about the space in which the home appliance 100 is arranged may be prestored in the memory 214 or the server. For example, for each of the home appliances 100 in the home that are registered to the server or the home appliance 100, information about a space in which each of the home appliances 100 is arranged may be defined and may be prestored in the server or the home appliance 100. According to an embodiment of the disclosure, information about each of the home appliances 100 may be stored by being matched with one of the spaces within the home.

According to an embodiment of the disclosure, the home appliance 100 may be stored by being matched with one of the spaces. The space that matches the home appliance 100 may be defined by user input. In addition, device information for each of the home appliances 100 may be stored together in the home appliance 100 or the server.

When the processor 210 determines that a person exists in the target space, the processor 210 counts the time for which the person is detected in the target space. Hereinafter, the target space in which the person is currently detected is referred to as a first space. The processor 210 uses the sensor detection value to calculate the duration during which the person is detected. The duration during which the person is detected is defined as a usage time. When the person is detected in the first space and then not detected, the usage time is reset to 0. When the usage time is longer than a reference time, the processor 210 determines that the user who is the detected person is using the first space. The reference time is a predefined time for which the first space is predicted to be used. The reference time may be defined for each of the spaces within the home.

When the processor 210 determines that the user is using the first space, the processor 210 determines the second space predicted to be used next by the user, based on user routine information. The user routine information includes a spatial movement prediction path of the user predicted in advance for the spaces within the home. For example, the spatial movement prediction path may be defined as bedroom/bathroom/dressing room/kitchen. The user routine information may be predefined and stored in the memory 214. According to an embodiment of the disclosure, the user routine information may correspond to a pattern learned by using a machine learning model.

When the processor 210 detects that the user uses the space in the first space (e.g., the bedroom or the bathroom that is the first space visited after waking up), which is the starting point of the spatial movement prediction path of the user routine information, the processor 210 determines that a user routine has started and determines the second space predicted to be used next by the user, based on the user routine information. For example, in a case where the first space that is the starting point of the spatial movement prediction path is the bedroom and the reference time for the bedroom is 2 minutes, when the processor 210 detects the user in the bedroom for 2 minutes or more, the processor 210 determines that a user routine has started and determines the second space predicted to be used next by the user, based on the user routine information. According to an embodiment of the disclosure, the first space of the user routine may be defined as “on the bed.” In addition, according to an embodiment of the disclosure, the first space of the user routine may be the first space the user visits after the bedroom.

When the second space is determined, the processor 210 controls the operation of at least one home appliance 100 arranged in the second space. For example, when the prediction path after the bedroom in the spatial movement prediction path is the bathroom and the home appliance to be controlled in the bathroom is a heater and a ventilation fan, the processor 210 operates the heater and the ventilation fan of the second space before the user moves to the second space. In this case, by operating the heater and the ventilation fan before the user moves to the bathroom, the temperature of the bathroom may be appropriately controlled in advance and the air quality of the bathroom may be improved in advance.

According to an embodiment of the disclosure, the processor 210 may control the operation of at least one home appliance of the second space a certain time before the time when the user is predicted to move to the second space. For example, when the reference time for the first space in the user routine information is 2 minutes and the usage time of the first space reaches the reference time, the processor 210 controls the operation of the at least one home appliance of the second space. According to an embodiment of the disclosure by controlling the at least one home appliance of the second space a certain time before the time when the user is predicted to move to the second space, the home appliance of the second space may be prevented from being controlled too quickly or too slowly.

The processor 210 may transmit a control signal for controlling the at least one home appliance of the second space to the at least one home appliance through the communication module 220. The processor 210 may transmit a control signal for controlling the home appliance of the second space to the home appliance of the second space through a server, or may directly transmit the control signal to the home appliance of the second space through short-range wireless communication.

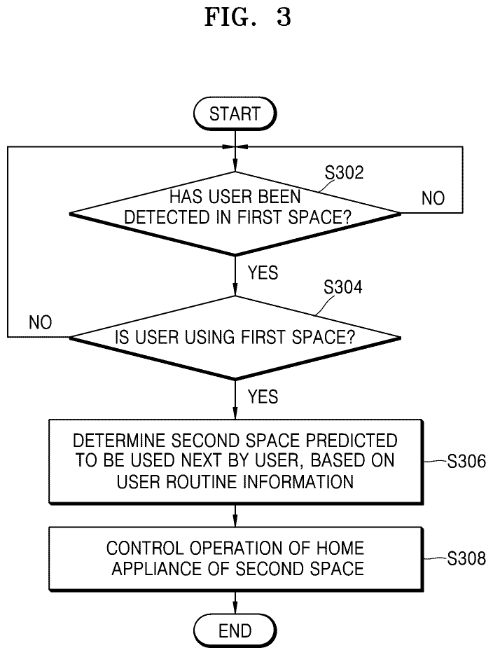

FIG. 3 is a flowchart of a home appliance control method according to an embodiment of the disclosure.

Referring to FIG. 3, the home appliance control method according to an embodiment of the disclosure may be performed by the server or the home appliance 100. The following description is given focusing on an embodiment of the disclosure in which the server performs the home appliance control method. However, this is for convenience of explanation, and an embodiment of the disclosure in which one of the home appliances 100 in the home performs the home appliance control method is also possible.

In operation S302, the server determines whether the user has been detected in the first space. According to an embodiment of the disclosure the server may determine whether the user has been detected in the first space by using the sensor detection value of the detection sensor 230 of the home appliance 100 arranged in the first space. In addition, according to an embodiment of the disclosure, the server may receive, from the home appliance 100 arranged in the first space, information about whether a person has been detected in the first space, and may determine whether a person has been detected in the first space, based on the received information.

In operation S304, when it is determined in operation S302 that the user has been detected, the server determines whether the user is using the first space. When the user is continuously detected for the reference time or more, the server may determine that the user is using the first space. When the user has been detected but has not been continuously detected for the reference time or more, the server determines that the user is not using the first space. For example, when the reference time is 2 minutes and the user has been continuously detected for 2 minutes or more, the server determines that the user is using the first space. On the other hand, when the reference time is 2 minutes and the user is no longer detected after being detected for 1 minute, the server determines that the user is not using the first space. The reference time is a predefined time for each space. The reference time may be defined in user pattern information. According to an embodiment of the disclosure, by determining whether the user is using the first space, based on the reference time, a case where the user is passing through the space may be distinguished from a case where the user is using the space according to a routine. Accordingly, an effect of significantly reducing automatic control malfunctions may be obtained.

When it is determined in operation S304 that the user is not using the first space, the server returns to operation S302 to determine whether the user has been detected in the first space. At this time, the server resets, to 0, the usage time that is the time for which the user has been continuously detected in the first space. When the user is detected again in the first space later, the server counts the usage time again from 0.

In operation S306, when it is determined in operation S304 that the user is using the first space, the server determines the second space predicted to be used next by the user, based on the user routine information. The user routine information includes a previously predicted spatial movement prediction path. The server determines the second space predicted to be used by the user after the first space, based on the spatial movement prediction path of the user routine information. The user routine information may be prestored. According to an embodiment of the disclosure, the user routine information may be information generated through learning by a machine learning model.

According to an embodiment of the disclosure the server may include the machine learning model that generates the user routine information. The server may obtain the user routine information by inputting, to the machine learning model, space usage information of the user's home collected in real time, and may use the obtained user routine information.

In operation S308, the server controls the operation of the home appliance 100 of the determined second space. The server may identify the home appliance 100 to be controlled in the second space and may control the identified home appliance 100.

Control conditions for the home appliance 100 of the second space may be predefined. For example, in operation S308, when the home appliance 100 of the second space is an air conditioner, the server may set the set temperature of the air conditioner to 25° C. and start a cooling operation of the air conditioner. In addition, in operation S308, when the home appliance 100 of the second space is an oven, the server may set the temperature of the oven to 200° C. and start preheating.

In order to control the home appliance 100 of the second space, the server may generate a control signal for controlling the home appliance 100 of the second space and transmit the control signal to the home appliance 100 of the second space. The control signal may include home appliance identification information, authentication information, control operation parameters, or the like.

The server may start controlling the home appliance 100 of the second space at the time point at which the user is predicted to move to the second space or a certain time before the time point at which the user is expected to move to the second space. For example, when the usage time for the first space reaches the reference time, the server may start controlling the home appliance 100 of the second space.

FIG. 4 is a diagram illustrating a home appliance, an external device, and a server according to an embodiment of the disclosure.

According to an embodiment of the disclosure, referring to FIG. 4, a plurality of home appliances 100 in the home communicate with an external device 410 and a server 420 through a communication module (not shown). Referring to FIG. 3, a first home appliance 100a, a second home appliance 100b, and a third home appliance 100c are collectively referred to as the home appliance 100. The home appliance 100 may be connected to other home appliances, the external device 410, or the server 420 via a network NET.

The server 420 may manage user account information and information about the home appliance 100 connected to a user account. For example, a user may access the server 420 through the external device 410 and create a user account. The user account may be identified by an identification and a password, which are set by the user. The server 420 may register the home appliance 100 to the user account according to a prescribed procedure. For example, the server 420 may register the home appliance 100 by linking identification information (e.g., a serial number or a media access control (MAC) address) of the home appliance 100 to the user account.

The external device 410 may include a communication module capable of communicating with the home appliance 100 and the server 420, a user interface that receives user input or outputs information to the user, at least one processor that controls the operation of the external device 410, and at least one memory that stores a program for controlling the operation of the external device 410.

The external device 410 may be carried by the user, or may be arranged in the user's home or office. The external device 410 may include, for example, a personal computer, a terminal, a portable telephone, a smartphone, a handheld device, a wearable device, or the like, but the disclosure is not limited thereto.

A program (e.g., an application) for controlling the home appliance 100 may be stored in memory of the external device 410. The external device 410 may be sold with the application for controlling the home appliance 100 installed thereon, or may be sold without the application for controlling the home appliance 100 installed thereon. When the external device 410 is sold without the application for controlling the home appliance 100 installed thereon, the user may download the application from an external server that provides the application and install the downloaded application on the external device 410.

The user may control the home appliance 100 by using the application installed on the external device 410. For example, when the user executes the application installed on the external device 410, identification information of the home appliance 100 connected to the same user account as the external device 410 may be displayed on an application execution window. The user may perform desired control on the home appliance 100 through the application execution window. When the user inputs a control command for the home appliance 100 through the application execution window, the external device 410 may directly transmit the control command to the home appliance 100 via the network, and may transmit the control command to the home appliance 100 via the server 420.

The application of the external device 410 may receive various user inputs for controlling the home appliance 100. The application provides a graphical user interface (GUI) for receiving various user inputs and receives user inputs through the GUI. While communicating with the server 420, the external device 410 updates state information of the home appliance 100 and provides the updated state information through the application. In addition, the external device 410 transmits, to the home appliance 100, user input received through the application while communicating with the server 420.

The network NET may include both wired and a wireless networks. The wired network includes a cable network or a telephone network, and the wireless network may include any network that transmits and receives signals through radio waves. The wired network and the wireless network may be connected to each other.

The network NET may include a WAN such as the Internet, a LAN formed around an AP, and a short-range wireless network such as a wireless personal area network (WPAN) that does not go through an AP. The short-range wireless network may include Bluetooth™ (IEEE 802.15.1), Zigbee (IEEE 802.15.4), WFD, NFC, Z-Wave, or the like, but the disclosure is not limited thereto.

The access point AP may connect a LAN, to which the home appliance 100 and the external device 410 are connected, to a WAN, to which the server 420 is connected. The home appliance 100 or the external device 410 may be connected to the server 430 via the WAN.

The access point AP may communicate with the home appliance 100 and the external device 410 by using the wireless communication such as Wi-Fi™ (Institute of Electrical and Electronics Engineers (IEEE) 802.11) and may connect to the WAN by using the wired communication.

The home appliance 100 may transmit operation or state information to the server 420 via the network NET. For example, the home appliance 100 may transmit operation or state information to the server 420 through Wi-Fi™ (IEEE 802.11) communication.

When the home appliance 100 is not provided with a Wi-Fi™ communication module, the home appliance 100 may transmit operation or state information to the server 420 through another home appliance having a Wi-Fi™ communication module. For example, when the home appliance 100 transmits operation or state information to another home appliance via a short-range wireless network (e.g., BLE communication), the other home appliance may transmit the operation or state information of the home appliance 100 to the server 420. In addition, for example, when the home appliance 100 is not provided with a Wi-Fi™ communication module, the home appliance 100 may be connected to a communication relay device by wire and may perform Wi-Fi™ communication through the communication relay device.

The home appliance 100 may provide the operation or state information of the home appliance 100 to the server 420 according to a user's prior approval. The transmission of information to the server 420 may be performed when a request is received from the server 420, may be performed when a specific event occurs in the home appliance 100, or may be performed periodically or in real time.

When the operation or state information is received from the home appliance 100, the server 420 may update information prestored in relation to the home appliance 100. The server 420 may transmit the operation or state information of the home appliance 100 to the external device 410 via the network NET.

When the request is received from the external device 410, the server 420 may transmit the operation or state information of the home appliance 100 to the external device 410. For example, when the user executes an application connected to the server 420 on the external device 410, the external device 410 may request and receive the operation or state information of the home appliance 100 from the server 420 through the application. When the operation or state information is received from the home appliance 100, the server 420 may transmit the operation or state information of the home appliance 100 to the external device 410 in real time. The server 420 may periodically transmit the operation or state of the home appliance 100 to the external device 410. The external device 410 may transmit the operation or state information of the home appliance 100 to the user by displaying the operation or state information of the home appliance 100 on the application execution window.

The home appliance 100 may obtain a variety of information from the server 420 and provide the obtained information to the user. In addition, the home appliance 100 may receive, from the server 420, a file for updating pre-installed software or data related to the pre-installed software and may update the pre-installed software or the data related to pre-installed software based on the received file.

The home appliance 100 may operate according to a control command received from the server 420. For example, when the home appliance 100 obtains a user's prior approval to operate according to the control command of the server 420 even without user input, the home appliance 100 may operate according to the control command received from the server 420. The control command received from the server 420 may include a control command input by the user through the external device 410 or a control command generated by the server 420 based on preset conditions, but the disclosure is not limited thereto.

FIG. 5 is a flowchart of a process in which a server, a first home appliance, and a second home appliance perform a home appliance control method, according to an embodiment of the disclosure.

According to an embodiment of the disclosure, referring to FIG. 5, a home appliance control method is performed by a server 420 that communicates with a plurality of home appliances 100. An embodiment of the disclosure in which the server 420 operates while communicating with a first home appliance 100a arranged in a first space and a second home appliance 100b arranged in a second space is described with reference to FIG. 5.

In operation S502, the first home appliance 100a arranged in the first space detects a user in the first space by using the sensor detection value of the detection sensor 230. The first home appliance 100a may determine whether the detected object is a person by using the sensor detection value. When the first home appliance 100a determines that the detected object is a person, the first home appliance 100a may generate a result indicating that the user has been detected.

In operation S504, the first home appliance 100a transmits, to the server 420, information indicating that the user has been detected in the first space. The first home appliance 100a may periodically transmit user detection information to the server 420 while the user is detected in the first space. For example, the first home appliance 100a may transmit the user detection information to the server 420 at a period of 1 second or less.

According to an embodiment of the disclosure, the first home appliance 100a and the second home appliance 100b may transmit, to the server 420, information indicating that the user has been detected in the space in which each home appliance is arranged or information indicating that the user has not been detected in the space in which each home appliance is installed. When the user is detected in the corresponding space, each home appliance may transmit, to the server 420, information indicating that the user has been detected. When the user is not detected in the corresponding space, each home appliance may transmit, to the server 420, information indicating that the user has not been detected. User detection information indicating that the user has been detected and user non-detection information indicating that the user has not been detected may be transmitted from each home appliance to the server 420 at a certain period. The transmission period of the user detection information and the transmission period of the user non-detection information may be set to be equal to or different from each other. According to an embodiment of the disclosure, the transmission period of user detection information may be set to be shorter than the transmission period of user non-detection information.

In operation S302, the server 420 determines whether the user has been detected in the first space. When the server 420 receives the user detection information from the first home appliance 100a, the server 420 determines that the user has been detected in the first space in operation S302.

In operation S304, when the server 420 determines in operation S302 that the user has been detected in the first space, the server 420 determines whether the user is using the first space. The server 420 defines the usage time by counting the duration during which the user detection information is received. When the usage time is greater than the reference time for the first space, the server 420 determines that the user is using the first space. When the usage time is less than the reference time for the first space, the server 420 determines that the user is not using the first space and returns to operation S302 to determine whether the user is detected in the first space.

In operation S306, when it is determined in operation S304 that the user is using the first space, the server 420 determines the second space predicted to be used next by the user, based on the user routine information. For example, when the spatial movement prediction path of the user routine information is defined in the order of a bedroom, a bathroom, a dressing room, and a living room and the first space is the bedroom, the server 420 determines that the second space is the bathroom.

In operation S308, the server 420 controls the operation of the second home appliance 100b of the second space. The server 420 identifies the second home appliance 100b to be controlled in the second space. When a plurality of home appliances are arranged in the second space, the server 420 may identify at least one second home appliance 100b to be controlled, based on prestored control target device information. For example, when a heater, a ventilation fan, and a bidet are installed in the second space, the server 420 may determine the heater and the ventilation fan as the second home appliance 100b to be controlled, and may not determine the bidet as the second home appliance 100b. Because the bidet is in the second space but is not included in the second home appliance 100b to be controlled, the bidet may be excluded from the object to be controlled according to the user routine information.

In operation S308, the server 420 generates a control signal for controlling the second home appliance 100b and transmits the control signal to the second home appliance 100b. The control signal may include identification information of the second home appliance 100b, authentication information, control operation parameters, or the like.

The second home appliance 100b receives the control signal from the server 420. In operation S506, the second home appliance 100b performs an operation based on the control signal received from the server 420. For example, the control signal may include identification information of the heater in the bathroom, authentication information registered in the server 420, a turn-on control signal for the heater, a set temperature for the heater, and a control signal for setting the heater to a heating mode. Based on the control signal, the second home appliance 100b identifies that the control signal received from the server 420 is for the corresponding device, authenticates the authority of the control signal, turns on the heater, sets the set temperature of the heater, and operates after setting the heater to a heating mode.

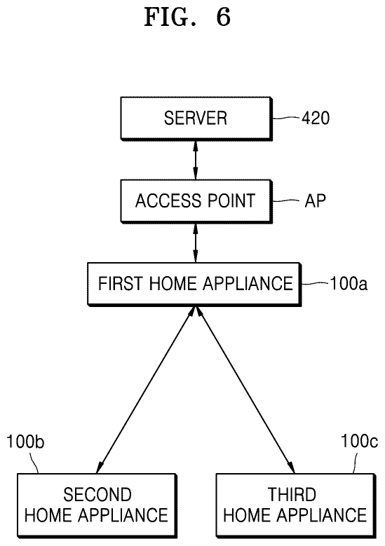

FIG. 6 is a diagram illustrating a process in which a plurality of home appliances operate while communicating with each other, according to an embodiment of the disclosure.

According to an embodiment of the disclosure, referring to FIG. 6, one of the home appliances may serve as the server 420, and the home appliances may perform the home appliance control method according to an embodiment of the disclosure while performing short-range wireless communication with each other. A case where the first home appliance 100a serves as the server 420 and the first home appliance 100a communicates with the second home appliance 100b and the third home appliance 100c is described as an example. The first home appliance 100a, the second home appliance 100b, and the third home appliance 100c are home appliances 100 arranged in different spaces within the home. The first home appliance 100a may be arranged in the first space, the second home appliance 100b may be arranged in the second space, and the third home appliance 100c may be arranged in the third space.

The first home appliance 100a may serve as the server 420. The first home appliance 100a may communicate with the second home appliance 100b and the third home appliance 100c through short-range wireless communication. For example, the first home appliance 100a may communicate with the second home appliance 100b and the third home appliance 100c through a short-range wireless communication scheme, such as Bluetooth, BLE, UWB, and WFD. When communicating with the second home appliance 100b and the third home appliance 100c, the first home appliance 100a may use the same communication scheme or use different communication schemes.

The first home appliance 100a may communicate with the server 420. The first home appliance 100a may communicate with the server 420 through the access point AP. The first home appliance 100a may provide, to the server 420, operation information, state information, etc. of the first home appliance 100a, the second home appliance 100b, or the third home appliance 100c. In addition, the first home appliance 100a may receive a certain control signal or data from the server 420.

The first home appliance 100a collects user detection information generated in the first home appliance 100a, the second home appliance 100b, or the third home appliance 100c. According to an embodiment of the disclosure, the first home appliance 100a may also collect user non-detection information generated in the first home appliance 100a, the second home appliance 100b, or the third home appliance 100c. The first home appliance 100a may perform operations S302, S304, S306, and S308 described above with reference to FIGS. 3 and 5, based on the user detection information collected or received from the first home appliance 100a, the second home appliance 100b, or the third home appliance 100c.

When the space that the user is using is the first space, the first home appliance 100a may control the first home appliance 100a itself or control other home appliances arranged in the first space. The first home appliance 100a may control the operation of the first home appliance 100a itself by generating the control signal. In addition, the first home appliance 100a may control other home appliances of the first space by generating a control signal and transmitting the control signal to the other home appliances of the first space.

When the space that the user is using is the second space or the third space, the first home appliance 100a generates a control signal for controlling the second home appliance 100b or the third home appliance 100c and transmits the control signal to the second home appliance 100b or the third home appliance 100c.

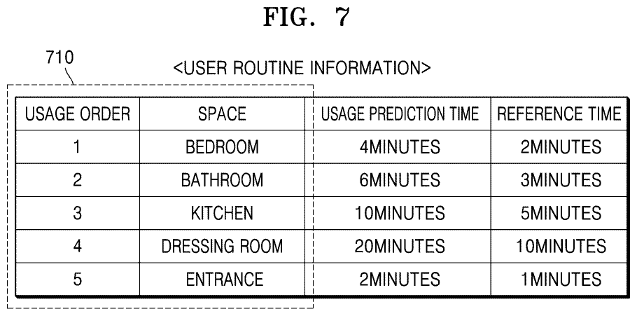

FIG. 7 is a diagram illustrating user routine information according to an embodiment of the disclosure.

According to an embodiment of the disclosure, referring to FIG. 7, the user routine information 710 may include a spatial movement prediction path and usage prediction time information for each space. The spatial movement prediction path represents the movement order of space in which the user is predicted to move. The spatial movement prediction path may be defined as moving in the order of a bedroom, a bathroom, a dressing room, a kitchen, and an entrance.

The usage prediction time indicates the time for which the user is predicted to use each space. The usage prediction time is individually defined for each space. For example, the usage prediction time is defined as 4 minutes for the bedroom, 6 minutes for the bathroom, 10 minutes for the dressing room, 20 minutes for the kitchen, and 2 minutes for the entrance.

According to an embodiment of the disclosure, the user routine information may further include reference time information. The reference time information represents the reference time for determining whether each space is in use. The reference time information is individually defined for each space. For example, the reference time is defined as 2 minutes for the bedroom, 3 minutes for the bathroom, 5 minutes for the dressing room, 10 minutes for the kitchen, and 1 minutes for the entrance. According to an embodiment of the disclosure, the reference time may be defined differently or equally for each space.

According to an embodiment of the disclosure, some of the user routine information may be defined as one user routine information. In this case, the user routine information may be commonly used for all users. According to an embodiment of the disclosure, the user routine information may be individually defined for each house. Each home may be identified by the user account with which the hole is registered. The user routine information may be defined for each user account.

In addition, according to an embodiment of the disclosure, the user routine information may be defined differently based on additional information, such as day of the week, weather, season, or user identification information. In this case, the server 420 or the home appliance 100 may store a plurality of pieces of candidate user routine information corresponding to each piece of additional information, and may determine the corresponding candidate user routine information as the user routine information, based on the additional information.

According to an embodiment of the disclosure, the user routine information may be information learned by a machine learning model. The server 420 or the home appliance 100 may collect training data including the space usage order and the usage time within the home, may learn the user routine information by using the machine learning model, and may generate the user routine information. In this case, the user routine information may be generated after a certain period of time has passed after the home appliance 100 is installed in the home and learning is started. For example, after the home appliance 100 is installed in the home, the home appliance 100 is registered in the server 420, and the collection and learning of the training data is started with the server 420, the user routine information may be determined when the reliability of the user routine information is greater than or equal to the reference value.

In addition, according to an embodiment of the disclosure, the user routine information may be defined by user input. For example, a GUI is provided that allows the user routine information to be input through the program or the application provided on the external device 410 such as a smartphone, and the user routine information may be defined based on the user input through the GUI. For example, the user may directly input the spatial movement prediction path in turn and input the usage prediction time for each space through the GUI of the external device 410. The server 420 or the home appliance 100 may define the spatial movement prediction path based on the user input and may define the reference time for each space.

In addition, according to one embodiment of the disclosure, the user routine information may be defined by using average routine information according to user attribute information. The user attribute information may include, for example, at least one of age, gender, age range, or occupation. According to an embodiment of the disclosure, user attributes may be defined by user input. According to an embodiment of the disclosure, the user attributes may be defined by user information of the user account corresponding to the home appliance 100. The server 420 or the home appliance 100 may prestore average routine information according to the user attribute information. The home appliance 100 may obtain, from the server 420, the user routine information corresponding to the user attribute information.

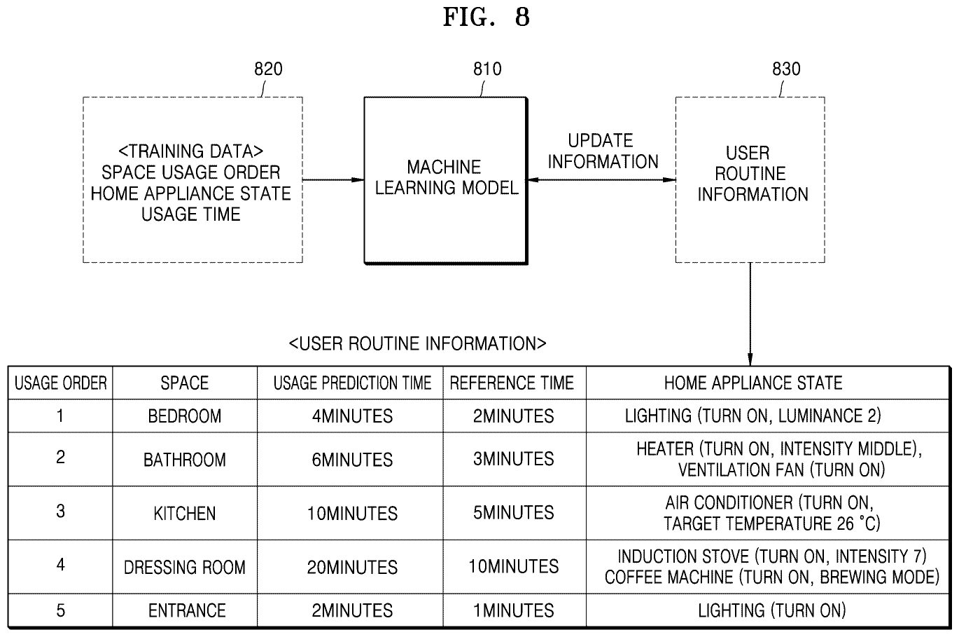

A process of generating the user routine information according to an embodiment of the disclosure is described with reference to FIGS. 8, 9, 10, 11, and 12.

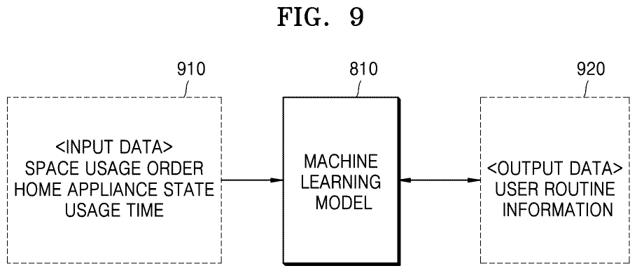

The user routine information may be generated by inputting, to a machine learning model 810, data including space usage order, home appliance state, and usage time. An embodiment of the disclosure in which the user routine information is generated by using the space usage order, the home appliance state, and the usage time is described below with reference to FIGS. 8 and 9.

According to an embodiment of the disclosure, the user routine information may be previously generated by using the machine learning model 810 during a product development or production stage, the previously generated user routine information may be prestored in the server 420 or the home appliance 100, such that the server 420 or the home appliance 100 may use the prestored user routine information. An embodiment of the disclosure in which the prestored user routine information is used is described below with reference to FIG. 8. In addition, according to an embodiment of the disclosure, after product installation, the server 420 or the home appliance 100 may input the collected input data to the machine learning model 810 and may generate the user routine information, such that the server 420 or the home appliance 100 may use the generated user routine information. An embodiment of the disclosure in which the user routine information is generated by using the machine learning model 810 after product installation and the generated user routine information is used is described below with reference to FIG. 9.

FIG. 8 is a diagram illustrating a process of learning user routine information by using a machine learning model, according to an embodiment of the disclosure.

According to an embodiment of the disclosure, referring to FIG. 8, user routine information 830 may be learned by using the machine learning model 810. The user routine information may be learned and defined by the machine learning model 810.

The operation of the machine learning model 810 may be performed by the server 420 or the home appliance 100. The machine learning model 810 updates the user routine information 830 while learning the user routine information 830 by using training data 820. The machine learning model 810 may determine the reliability of the user routine information 830 and, when the reliability is greater than or equal to a reference value, may determine the user routine information 830. The machine learning model 810 may receive the training data 820 and learn the user routine information 830. The training data 820 may include a usage space (zone (t)) of a current unit time, a time spent in a current usage space, and home appliance state information (device state (t)) of the current unit time. The output of the machine learning model 810 may include a predicted usage space (zone (t+1)) of a next unit time and home appliance state information (device state (t+1)) of the next unit time. The unit time may be variously determined, for example, 1 minute, 5 minutes, or 1 hour.

The usage space may be defined as one of a plurality of predefined spaces within the home.

The home appliance state information may correspond to state information of each of a plurality of home appliances in the home. The home appliance state information may include at least one of an operation/non-operation, an operation mode, or an operation parameter. For example, when the home appliance corresponds to an air conditioner, the operation mode may include a cooling mode, a blowing mode, a heating mode, etc. For example, when the home appliance corresponds to a cooking appliance, the operation mode may include a preheating mode, a cooking mode, etc. For example, when the home appliance corresponds to an air conditioner, the operating parameter may include a target temperature, a wind intensity, etc. For example, when the home appliance corresponds to a cooking appliance, the operating parameter may include a target temperature, a heating intensity, a cooking time, etc. The server 420 or the home appliance 100 may post-process the output of the machine learning model 810 to generate the user routine information 830 in a predefined form.

The server 420 or the home appliance 100 collects the training data 820 from the home appliances 100 in the home. According to an embodiment of the disclosure, the server 420 or the home appliance 100 may collect, as the training data, the usage space (zone (t)) of the current unit time, the time spent in the current usage space, and the home appliance state information (device state (t)) of the current unit time. The server 420 or the home appliance 100 may store the collected training data in a database, memory, etc., may pre-process the collected training data, and input the pre-processed training data to the machine learning model 810 as the training data of the machine learning model 810.

The machine learning model 810 may be implemented by using learning models with various structures. According to an embodiment of the disclosure, the machine learning model 810 may correspond to a time-series learning model. Additionally, according to an embodiment of the disclosure, the machine learning model 810 may include at least one of long short term memory (LSTM), recurrent neural network (RNN), or convolutional neural network (CNN), or any combination thereof.

The machine learning model 810 calculates and extracts a conditional probability (p) for changes in the usage space and the state of the home appliance, based on the training data. For example, when the usage space of the current time zone is a dressing room, the machine learning model 810 calculates the probability that each space will correspond to a next used space. When the conditional probability (p) of the next usage space for one space is greater than or equal to a reference value (h), the machine learning model 810 defines the corresponding space movement path as a pattern. For example, when the usage space of the current time zone is a dressing room and the probability that the next usage space will be a kitchen is greater than or equal to 0.85, which is the reference value (h), the spatial movement path from the dressing room to the kitchen is defined as a pattern.

When the pattern is defined, the machine learning model 810 defines the time zone, usage space, usage time, and home appliance state information corresponding to the pattern and converts the same into a rule. For example, when the time zone, the usage space, the usage time, and the home appliance state conditions are satisfied, the machine learning model 810 may generate a rule for presetting the next usage space and the home appliance state information of the next usage space.

The machine learning model 810 generates a spatial movement path by accumulating spatial movement paths defined as patterns and defines the start and end of the pattern. For example, when the spatial movement path of the user is a bedroom, a bathroom, a dressing room, a kitchen, a living room, and an entrance and the path defined as the pattern by the conditional probability (p) is a bedroom, a bathroom, a dressing room, and a kitchen, the machine learning model 810 defines the bedroom as the start of the pattern and the kitchen as the end of the pattern.

In addition, the machine learning model 810 extracts pattern features from the path defined as the pattern. The pattern features may include, for example, at least one of a list of home appliances in use, driving/operation time zone, home appliance state, weather, or home type.

When the paths defined as the patterns in the machine learning model 810 are accumulated and converted into the rule, the machine learning model 810 generates the user routine information 830 from the rule. According to an embodiment of the disclosure, the generation of the user routine information 830 is may be performed directly by the machine learning model 810. In addition, according to an embodiment of the disclosure, the user routine information 830 may be generated by a post-processing process based on the rule generated from the machine learning model 810.

According to an embodiment of the disclosure, the user routine information 830 may include a spatial movement prediction path defined by the rule, a usage prediction time, a reference time, and home appliance state information in each space. The user routine information 830 may define home appliance state information of the space when the user uses each space. Referring to FIG. 8, the home appliance state information includes the type, state, and operating parameter of each home appliance of the space.

According to an embodiment of the disclosure, the usage prediction time, which is the average time the user uses each space, may be learned by the machine learning model 810. The user routine information 830 may include usage prediction time information for each space. As illustrated in FIG. 8, the usage prediction time information may be defined for each space.

The reference time may be determined by multiplying a usage prediction time by a certain first reference ratio. For example, the reference time may be determined as a value obtained by multiplying the usage prediction time by 0.5. The first reference ratio may be determined in the range of 0.5 to 1.

The learning of the user routine information 830 by the machine learning model 810 may be performed during a home appliance product development process, a home appliance product production process, or a home appliance use process. When the user routine information 830 is generated by the machine learning model 810, the generated user routine information 830 may be stored in at least one of the server 420 or the home appliance 100.

According to an embodiment of the disclosure, a plurality of home appliances 100 in the home may be grouped. The home appliances 100 may be grouped for each device used in the same space. In addition, each group of the home appliances 100 may match one of the spaces. The machine learning model 810 may group at least one home appliance 100 used in the same space and may generate user routine information matching each group with each space.

FIG. 9 is a diagram illustrating a process of generating user routine information from a machine learning model, according to an embodiment of the disclosure.

According to an embodiment of the disclosure, referring to FIG. 9, the server 420 or the home appliance 100 may generate and use the user routine information by inputting the space usage order, home appliance state, and usage time information collected in real time to the machine learning model 810, instead of using the prestored user routine information. The server 420 or the home appliance 100 collects the usage space, the home appliance state, and the usage time according to the time zone in real time. The server 420 or the home appliance 100 inputs, to the machine learning model 810, the space usage, the home appliance state, and the usage time collected according to the time zone. The machine learning model 810 outputs the user routine information 920 as output data, based on the usage space, home appliance state, and usage time according to the time zone, which are included in the input data 910. The machine learning model 810 may determine whether the input data 910 corresponds to a predefined pattern or rule and, when the input data 910 corresponds to the pattern or rule, may generate and output corresponding user routine information.

According to an embodiment of the disclosure, when the home appliance control method is performed by the home appliance 100, the home appliance 100 may transmit the collected input data 910 to the server 420 and may obtain the user routine information 920 from the server 420. The server 420 performs the operation of the machine learning model 810. When the server 420 receives the input data 910, the server 420 may input the input data 910 to the machine learning model 810 and may transmit, to the home appliance 100, the user routine information output from the machine learning model 810.

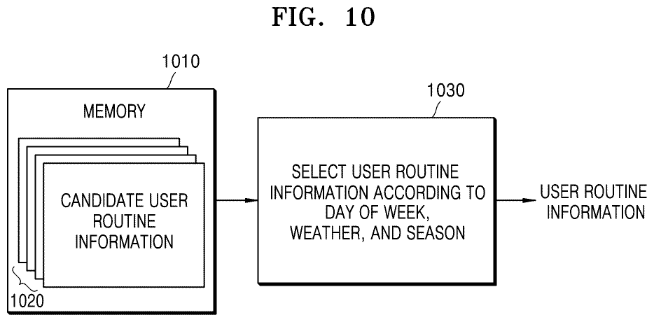

An embodiment of the disclosure in which the user routine information is generated is described below with reference to FIGS. 10, 11, and 12.

According to an embodiment of the disclosure, the user routine information may be generated by using space usage order, home appliance state, usage time, day of the week, weather, and season. An embodiment of the disclosure in which the user routine information is generated by using space usage order, home appliance state, usage time, day of the week, weather, and season is described below with reference to FIGS. 10, 11, and 12.

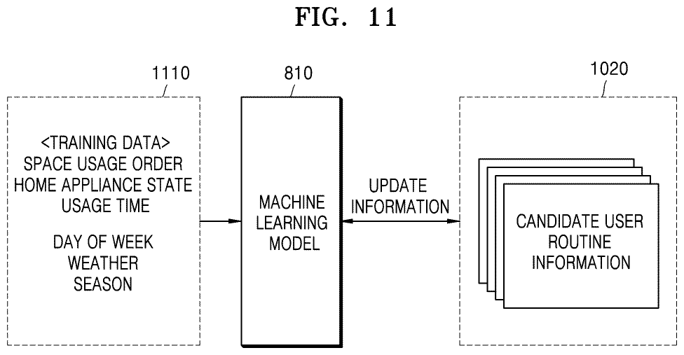

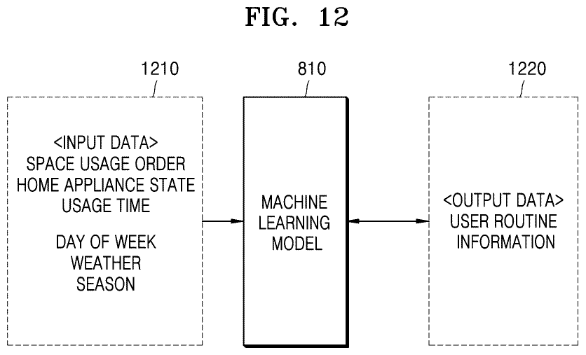

According to an embodiment of the disclosure, the user routine information may be previously generated by using the machine learning model 810 during a product development or production stage, the previously generated user routine information may be prestored in the server 420 or the home appliance 100, such that the server 420 or the home appliance 100 may use the prestored user routine information. An embodiment of the disclosure in which the prestored user routine information is used is described with below reference to FIGS. 10 and 11. In addition, according to an embodiment of the disclosure, after product installation, the server 420 or the home appliance 100 may input the collected input data to the machine learning model 810 and may generate the user routine information, such that the server 420 or the home appliance 100 may use the generated user routine information. An embodiment of the disclosure in which the user routine information is generated by using the machine learning model 810 after product installation and the generated user routine information is used is described below with reference to FIG. 12.

FIG. 10 is a diagram illustrating a process of determining user routine information from a plurality of pieces of candidate user routine information according to additional information, according to an embodiment of the disclosure.

According to an embodiment of the disclosure, referring to FIG. 10, the server 420 or the home appliance 100 may select user routine information from a plurality of pieces of candidate user routine information 1020, based on additional information. The additional information may include, for example, at least one of the day of the week, weather, or season.

The pieces of candidate user routine information 1020 may be defined according to the additional information. The additional information may include one or more pieces of information. For example, when the additional information includes at least one of day of the week, weather, or season, the candidate user routine information 1020 may be defined according to the day of the week, may be determined by the weather, may be defined by the season, may be defined by the day of the week and the weather, may be defined according to the day of the week and the season, or may be defined according to the day of the week, the weather, and the season. In addition, according to an embodiment of the disclosure, the candidate user routine information 1020 may include default candidate user routine information 1020 that is used when there is no additional information.

The candidate user routine information 1020 may be prestored in the server 420 or the memory 1010 of the home appliance 100. According to an embodiment of the disclosure, the candidate user routine information 1020 may be updated by the server 420.

In operation S1030, the server 420 or the home appliance 100 may select one of the pieces of candidate user routine information based on the additional information. The server 420 or the home appliance 100 may collect additional information for some or all of categories defined in the additional information. The server 420 or the home appliance 100 selects one of the pieces of candidate user routine information based on the collected additional information. For example, when the day of the week and the weather are collected from among the pieces of additional information, the server 420 or the home appliance 100 selects candidate user routine information that corresponds to the day of the week and the weather and does not correspond to the season, and determines the selected candidate user routine information as the user routine information.

FIG. 11 is a diagram illustrating a process of generating a plurality of pieces of candidate user routine information by using a machine learning model, according to an embodiment of the disclosure. Referring to FIG. 11, descriptions redundant with those provided above with reference to FIG. 8 are omitted and the following description is given focusing on differences.

According to an embodiment of the disclosure, referring to FIG. 11, a plurality of pieces of candidate user routine information 1020 may be learned by using a machine learning model 810. The candidate user routine information 1020 may be learned and defined by the machine learning model 810.

The operation of the machine learning model 810 may be performed by the server 420 or the home appliance 100. The machine learning model 810 updates the pieces of candidate user routine information 1020 while learning the pieces of candidate user routine information 1020 by using the training data 1110.

The server 420 or the home appliance 100 collects the training data 1110 from the home appliances 100 in the home. According to an embodiment of the disclosure, the server 420 or the home appliance 100 may collect, as the training data 1110, a usage space (zone (t)) of a current unit time, a time spent in a current usage space, and home appliance state information (device state (t)) of the current unit time. In addition, the server 420 or the home appliance 100 obtains at least one of day of the week, weather, or season information as additional information. The additional information may be collected from some or all of the defined categories (e.g., day of the week, weather, and season). The server 420 or the home appliance 100 may store the collected training data in a database, memory, etc., may pre-process the collected training data, and input the pre-processed training data to the machine learning model 810 as the training data of the machine learning model 810.

The machine learning model 810 may be implemented by using learning models with various structures. According to an embodiment of the disclosure, the machine learning model 810 may correspond to a time-series learning model. Additionally, according to an embodiment of the disclosure, the machine learning model 810 may include at least one of LSTM, RNN, or CNN, or any combination thereof.

The machine learning model 810 calculates and extracts a conditional probability (p) for changes in the usage space and the state of the home appliance, based on the training data. For example, when the usage space of the current time zone is a dressing room, the machine learning model 810 calculates the probability that each space will correspond to a next used space. According to an embodiment of the disclosure, the machine learning model 810 may calculate a conditional probability (p) by adding the additional information to the condition. For example, when the usage space of the current time zone is a dressing room and the day of the week is a weekday, the machine learning model 810 calculates the probability that each space will correspond to the next used space.

When the conditional probability (p) of the next usage space for one space is greater than or equal to a reference value (h), the machine learning model 810 defines the corresponding space movement path as a pattern. For example, when the usage space of the current time zone is a dressing room, the day of the week is a weekday, and the probability that the next usage space will be a kitchen is greater than or equal to 0.85, which is the reference value (h), the space movement path from the dressing room to the kitchen on weekdays is defined as a pattern.

When the pattern is defined, the machine learning model 810 defines the time zone, usage space, usage time, additional information, and home appliance state information corresponding to the pattern and converts the same into a rule. For example, when the time zone, the usage space, the usage time, the additional information, and the home appliance state conditions are satisfied, the machine learning model 810 may generate a rule for presetting the next usage space and the home appliance state information of the next usage space.

The machine learning model 810 generates a spatial movement path by accumulating spatial movement paths defined as patterns and defines the start and end of the pattern. For example, when the user's spatial movement path is a bedroom, a bathroom, a dressing room, a kitchen, a living room, and an entrance and the path defined as the pattern by the conditional probability (p) is a bedroom, a bathroom, a dressing room, and a kitchen, the machine learning model 810 defines the bedroom as the start of the pattern and the kitchen as the end of the pattern. The start and end of the pattern may be defined differently depending on the additional information.

In addition, the machine learning model 810 extracts pattern features from the path defined as the pattern. The pattern features may include, for example, at least one of a list of home appliances in use, driving/operation time zone, weather, day of the week, season, or home type.

When the paths defined as the patterns in the machine learning model 810 are accumulated and converted into the rule, the machine learning model 810 generates the candidate user routine information 1020 from the rule. The pattern and the rule may be defined differently depending on the additional information. According to an embodiment of the disclosure, a plurality of pieces of candidate user routine information 1020 defined according to each piece of additional information may be learned and generated. According to an embodiment of the disclosure, the generation of the pieces of candidate user routine information 1020 may be performed directly by the machine learning model 810. In addition, according to an embodiment of the disclosure, the pieces of candidate user routine information 1020 may be generated by a post-processing process based on the rule generated from the machine learning model 810.

According to an embodiment of the disclosure, the candidate user routine information 1020 may include a spatial movement prediction path defined by the rule, a usage prediction time, a reference time, home appliance state information in each space, and additional information. The candidate user routine information 1020 may define home appliance state information of the space when the user uses each space.

The learning of the candidate user routine information 1020 by the machine learning model 810 may be performed during a home appliance product development process, a home appliance product production process, or a home appliance use process. When the candidate user routine information 1020 is generated by the machine learning model 810, the generated candidate user routine information 1020 may be stored in at least one of the server 420 or the home appliance 100.

FIG. 12 is a diagram illustrating a process of generating user routine information from a machine learning model, according to an embodiment of the disclosure.

According to an embodiment of the disclosure, referring to FIG. 12, the server 420 or the home appliance 100 may generate and use the user routine information by inputting the space usage order, home appliance state, usage time information, and additional information collected in real time to the machine learning model 810, instead of using the prestored user routine information. The server 420 or the home appliance 100 collects the usage space, the home appliance state, and the usage time according to the time zone in real time. In addition, the server 420 or the home appliance 100 may obtain the additional information within a system or from a certain server. The server 420 or the home appliance 100 inputs, to the machine learning model 810, the space usage, the home appliance state, the usage time, and the additional information collected according to the time zone. The machine learning model 810 outputs the user routine information as output data 1220, based on the usage space, the home appliance state, the usage time, the additional information according to the time zone, which are included in the input data 1210. The machine learning model 810 may determine whether the input data 1210 corresponds to a predefined pattern or rule and, when the input data 910 corresponds to the pattern or rule, may generate and output corresponding user routine information.

According to an embodiment of the disclosure, when the home appliance control method is performed by the home appliance 100, the home appliance 100 may transmit at least some pieces of the collected input data 1210 to the server 420 and may obtain the user routine information 920 from the server 420. When the additional information may be collected from the server 420, the home appliance 100 may transmit the space usage order, the home appliance state, and the usage time information to the server 420, and the server 420 may input, to the machine learning model 810, the information received from the home appliance 100 and the additional information collected by the server 420. The server 420 performs the operation of the machine learning model 810. When the server 420 receives some or all pieces of the input data 1210, the server 420 may input the input data 1210 to the machine learning model 810 and may transmit, to the home appliance 100, the user routine information output from the machine learning model 810.

As in an embodiment of the disclosure when the user routine information 1220 is obtained by inputting the input data 1210 to the machine learning model 810, the server 420 or the home appliance 100 may not prestore a plurality of pieces of candidate user routine information.

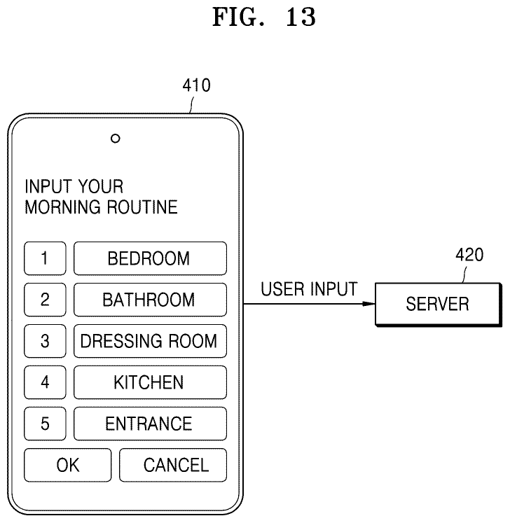

FIG. 13 is a diagram illustrating a process of receiving user routine information from a user, according to an embodiment of the disclosure.

According to an embodiment of the disclosure, referring to FIG. 13, the user routine information may be generated based on user input. According to an embodiment of the disclosure, the user routine information may be input through a program or an application of the external device 410. The external device 410 may provide a GUI that allows the user routine information to be input and may receive the user routine information through the GUI. The external device 410 transmits, to the server 420, the user input received through the GUI. The server 420 generates the user routine information based on the user input that is input through the external device 410. According to an embodiment of the disclosure, the external device 410 may receive usage prediction time information for each space as the user input. The server 420 may determine the usage prediction time for each space based on the user input.

The server 420 may generate and store the user routine information based on the user input. In addition, the server 420 may transmit, to the home appliance 100, the user routine information generated by the user input.

According to an embodiment of the disclosure, the external device 410 may receive the user routine information from the user, based on additional information. For example, the user may input user routine information for weekdays and user routine information for weekends. In this case, the server 420 may generate and store candidate user routine information based on the additional information, based on the user input of the external device 410.

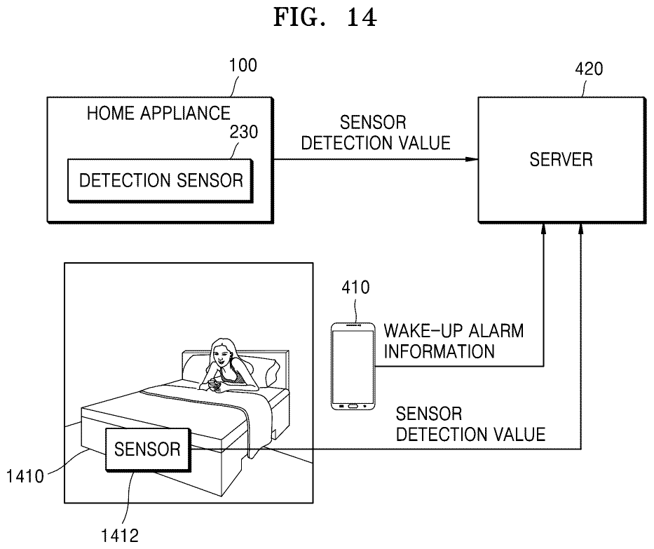

FIG. 14 is a diagram illustrating a process in which a home appliance is operated based on a wake-up event of a user, according to an embodiment of the disclosure.

According to an embodiment of the disclosure, referring to FIG. 14, the home appliance control method may be operated based on a wake-up event of a user. When the starting space of the user routine information is a bedroom, the home appliance control method may start counting the usage time for the bedroom when the wake-up event of the user is detected.

The wake-up event is an event in which a user transitions from a sleeping state to a waking state. The wake-up event may be detected based on various types of sensors or information.

According to an embodiment of the disclosure, the wake-up event may be detected based on the sensor detection value of the detection sensor 230 of the home appliance 100 arranged in the bedroom. When a person is detected in the bedroom based on the sensor detection value of the detection sensor 230 but the movement of the person is less than a reference value, the home appliance 100 determines that the person is sleeping. Thereafter, when it is determined that the movement of the person in the bedroom is greater than or equal to the reference value, based on the sensor detection value of the detection sensor 230, the home appliance 100 or the server 420 detects a wake-up event of a user. According to an embodiment of the disclosure, the home appliance 100 may transmit the sensor detection value to the server 420, and the server 420 may detect the wake-up event of the user based on the sensor detection value. In addition, according to an embodiment of the disclosure, the home appliance 100 may detect the wake-up event based on the sensor detection value and transmit the wake-up event to the server 420.

Furthermore, according to an embodiment of the disclosure, the server 420 or the home appliance 100 may detect the wake-up event of the user based on a sensor detection value of a sensor 1412 arranged in a bed 1410. The bed 1410 includes the sensor 1412 arranged in a certain structure. For example, the sensor 1412 may be arranged in at least one of a frame or a mattress of the bed 1410. The sensor 1412 is a motion sensor that detects the movement of the user in the bed 1410. The sensor 1412 may include, for example, an acceleration sensor, a gyro sensor, or a vibration sensor. The sensor detection value of the bed 1410 indicates the movement of the user. The sensor detection value of the sensor 1412 of the bed 1410 may be transmitted to the server 420. The server 420 may detect the wake-up event of the user based on the sensor detection value of the sensor 1412 of the bed 1410. According to an embodiment of the disclosure, the sensor detection value of the sensor 1412 may be transmitted to the home appliance 100, and the home appliance 100 may detect the wake-up event based on the sensor detection value of the sensor 1412.

In addition, according to an embodiment of the disclosure, the server 420 may receive a wearable device detection value received from a wearable device 1420 and detect a wake-up event. According to an embodiment of the disclosure, the wearable device detection value may include at least one of a motion detection value, a body temperature, a heart rate, or an electrocardiogram. The server 420 may determine whether the user has woken up, based on the wearable device detection value. When it is determined that the user has woken up, the server 420 may detect a wake-up event. In addition, according to an embodiment of the disclosure, the wearable device detection value may be a detection value obtained by detecting the wake-up event.

In addition, according to an embodiment of the disclosure, the server 420 may detect the wake-up event of the user, based on wake-up alarm information of the external device 410. The external device 410 may correspond to, for example, a smartphone, a tablet personal computer (PC), or a wearable device. The external device 410 may output a wake-up alarm at a set time. When there is an operation to stop the alarm after outputting the wake-up alarm, the external device 410 may generate wake-up alarm information indicating that the wake-up alarm has been stopped and may transmit the wake-up alarm information to the server 420. The server 420 may detect the wake-up event of the user based on the wake-up alarm information indicating that the wake-up alarm has been stopped. According to an embodiment of the disclosure, the wake-up alarm information may be transmitted to the home appliance 100, and the home appliance 100 may detect the wake-up event based on the wake-up alarm information.

According to an embodiment of the disclosure, when the server 420 or the home appliance 100 detects the wake-up event of the user, the server 420 or the home appliance 100 may control at least one home appliance 100 of the predesignated first space. The first space that the user uses after waking up may be defined as user routine information. According to an embodiment of the disclosure, the first space that the user uses after waking up may be predesignated and stored in the server 420 or the home appliance 100. In addition, the home appliance 100 to be used in the first space after waking up may be predesignated and stored in the server 420 or the home appliance 100. When the wake-up event of the user is detected, the server 420 or the home appliance 100 controls the predesignated home appliance 100 of the first space. For example, when the server 420 or the home appliance 100 detects the wake-up event of the user, the server 420 or the home appliance 100 may operate an air heater and a water heater of a bathroom corresponding to the first space. According to an embodiment of the disclosure, by controlling the predesignated home appliance 100 of the predesignated space in response to the wake-up event of the user, an effect of allowing the user to conveniently use the next space after waking up may be obtained.

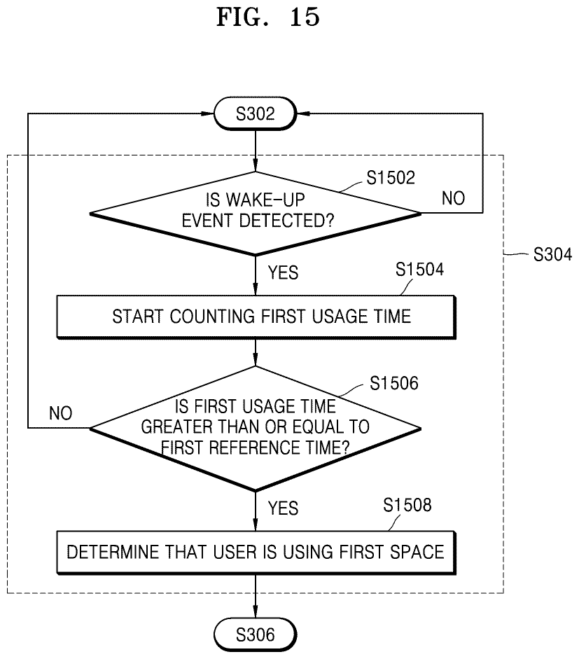

FIG. 15 is a diagram illustrating a process in which a home appliance is operated based on a wake-up event, according to an embodiment of the disclosure.

According to an embodiment of the disclosure, referring to FIG. 15, when the user is detected in the first space, the usage time may be counted from after the wake-up event of the user is detected. Even when the user is detected in the first space, the server 420 or the home appliance 100 may not count the usage time when the server 420 or the home appliance 100 determines that the user is sleeping.

When the user is detected in the first space in operation S302 described above with reference to FIG. 3, the server 420 or the home appliance 100 detects the wake-up event in operation S1502. As described above with reference to FIG. 14, the wake-up event may be detected by using the sensor detection value of the detection sensor 230 of the home appliance 100, may be detected by using the sensor detection value of the sensor 1412 of the bed 1410, or may be detected based on the wake-up alarm information of the external device 410.

In operation S1504, when the wake-up event is detected in operation S1502, the server 420 or the home appliance 100 starts counting the first usage time, which is the time when it is determined that the user uses the first space. Even when the user is detected in the first space, the server 420 or the home appliance 100 may not count the first usage time before the wake-up event is detected.

According to an embodiment of the disclosure, the server 420 or the home appliance 100 may start counting the first usage time based on the detection of the wake-up event only when the first space is a bedroom, and may not consider the wake-up event for spaces other than the bedroom. In addition, according to an embodiment of the disclosure, the server 420 or the home appliance 100 may start counting the first usage time based on the detection of the wake-up event only when the sleeping state of the user is detected in the bedroom, and may not consider the wake-up event when the user is detected in the bedroom but is not in a sleeping state.

In operation S1506, the server 420 or the home appliance 100 determines whether the first usage time is greater than or equal to the first reference time that is the reference time for the first space. When the counting of the first usage time is stopped because the user is no longer detected before the first usage time reaches the first reference time, the server 420 or the home appliance 100 returns to operation S302 to detect the user in the first space.

In operation S1508, when it is determined in operation S1506 that the first usage time is greater than or equal to the first reference time, the server 420 or the home appliance 100 determines that the user is using the first space.

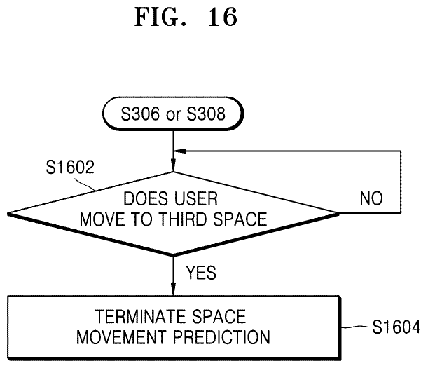

FIG. 16 is a diagram illustrating a process of terminating a spatial movement prediction operation according to a movement path of a user, according to an embodiment of the disclosure.

According to an embodiment of the disclosure, referring to FIG. 16, in operation S1602, the server 420 or the home appliance 100 determines whether the user moves to the third space, instead of moving to the second space, after operation S306 of determining the second space based on the user routine information or operation S308 of controlling the operation of the home appliance of the second space. In operation S1604, when the user moves to the third space, which is a different path from the user routine information, instead of moving to the second space, the server 420 or the home appliance 100 may terminate the space movement prediction operation of the user. When the server 420 or the home appliance 100 determines that the user moves differently from the user routine information, the user is in a state of not following the routine. Accordingly, the server 420 or the home appliance 100 may terminate the spatial movement prediction operation based on the user routine information.

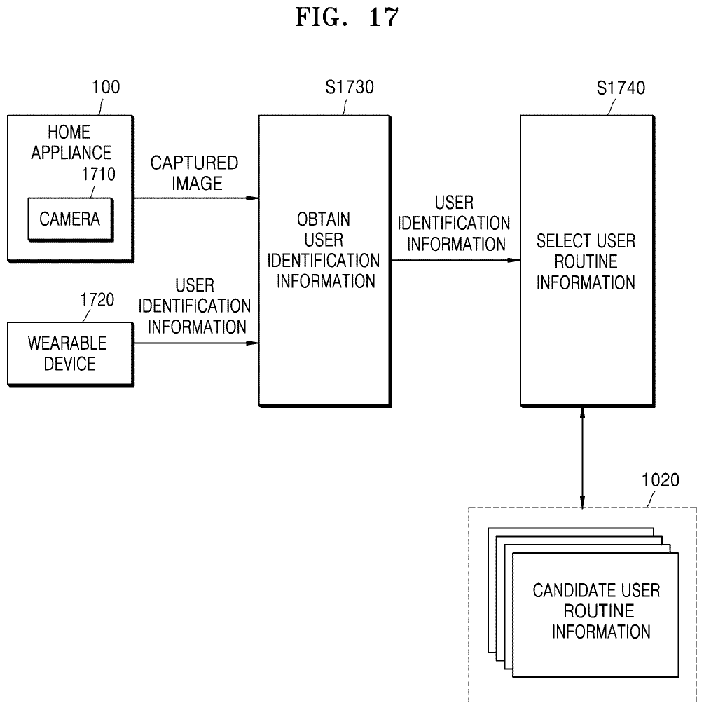

FIG. 17 is a diagram illustrating a process of identifying a user and determining user routine information for the identified user, according to an embodiment of the disclosure.

According to an embodiment of the disclosure, referring to FIG. 17, the server 420 or the home appliance 100 may identify a user detected in a target space and may perform spatial movement prediction by using user routine information corresponding to the identified user.

In operation S1730, the server 420 or the home appliance 100 obtains user identification information. The server 420 or the home appliance 100 may obtain information related to the user identification information from the home appliance 100 or the external device and may obtain user identification information by performing user identification using the obtained information.

In the embodiment of the disclosure illustrated in FIG. 17, the home appliance 100 includes a camera 1710. In operation S1730, the server 420 or the home appliance 100 may obtain user identification information by using an image captured by the camera 1710 of the home appliance 100. The camera 1710 may be arranged to photograph a target space in which the home appliance 100 is installed. The server 420 or the home appliance 100 may recognize a face of a person from the captured image and may use face recognition to identify a user who is using the target space. The server 420 or the home appliance 100 may prestore face information for at least one user and may obtain user identification information from the captured image by using the prestored face information. The user's face information may be input from the user through the external device 410, the home appliance 100, etc. and may be prestored. The server 420 or the home appliance 100 may perform face recognition from the captured image by using a machine learning model for face recognition or a certain face recognition algorithm, and may compare prestored faces with the recognized face.

In addition, according to an embodiment of the disclosure, the server 420 or the home appliance 100 may obtain user identification information by receiving the user identification information from a wearable device 1720. When the user is wearing the wearable device 1720, the wearable device 1720 may obtain user identification information. For example, the wearable device 1720 may obtain user identification information of a user registered as the owner of the wearable device 1720. When the user is wearing the wearable device 1720 within the target space, the server 420 or the home appliance 100 may determine that the user who uses the target space corresponds to the user identification information obtained from the wearable device 1720.

According to an embodiment of the disclosure, the server 420 or the home appliance 100 may recognize the position of the wearable device 1720 and obtain user identification information based on the recognized position of the wearable device 1720. According to an embodiment of the disclosure, the server 420 or the home appliance 100 may detect the position of the wearable device 1720 by using a UWB communication scheme. When the space in which the user is detected by the sensor detection value of the detection sensor 230 of the home appliance 100 corresponds to the space in which the wearable device 1720 is detected, the server 420 or the home appliance 100 may determine that the user identification information of the wearable device 1720 corresponds to the user of the target space.

In addition, according to an embodiment of the disclosure, the server 420 or the home appliance 100 may receive, from the user through the wearable device 1720, information about the space that the user is using. For example, when the server 420 or the home appliance 100 detects the user in the first space and determines that the user is wearing the wearable device 1720, the server 420 or the home appliance 100 may output, to the wearable device 1720, a query inquiring whether the user is using the space. When the user responds through the wearable device 1720 that the user is using the first space, the server 420 or the home appliance 100 determines that the user who uses the first space corresponds to the user of the wearable device 1720, and determines that the user identification information of the wearable device 1720 corresponds to the user of the first space.

According to an embodiment of the disclosure, operation S1730 of obtaining the user identification information may be performed only when a certain condition is satisfied. The certain condition may include, for example, a case where the user wears the wearable device 1720, a case where the home appliance 100 is provided with the camera 1710 and the server 420 or the home appliance 100 obtains the captured image, and a case where the user identification information is received through the external device 410 or the wearable device 1720. When the certain condition is satisfied, and thus, the user identification information is obtained, the server 420 or the home appliance 100 may select, as user routine information, candidate user routine information 1020 corresponding to the user identified by using the obtained user identification information. When the certain condition is not satisfied, and thus, the user identification information is not obtained (e.g., the user is not wearing the wearable device 1720), the server 420 or the home appliance 100 may select the candidate user routine information 1020 for which the user is not designated, and may use the selected candidate user routine information as the user routine information.

According to an embodiment of the disclosure, the server 420 or the home appliance 100 may always perform operation S1730 of obtaining user identification information before performing spatial movement prediction. The server 420 or the home appliance 100 may obtain the user identification information before performing spatial movement prediction, by using the captured image of the camera 1710 of the home appliance 100, by using the position information of the user's mobile device or wearable device, or by using a certain input including the user identification information. The server 420 or the home appliance 100 may select, as the user routine information, the candidate user routine information 1020 corresponding to the user identified by using the obtained user identification information.

In operation S1740, when the user identification information is obtained, the server 420 or the home appliance 100 selects the user routine information corresponding to the user identification information from among a plurality of pieces of candidate user routine information 1020. The pieces of candidate user routine information 1020 may include the candidate user routine information 1020 individually defined according to the user identification information. In addition, the pieces of candidate user routine information 1020 may include the candidate user routine information 1020 for which the user is not designated. When the user identification information is obtained, the server 420 or the home appliance 100 selects the candidate user routine information 1020 corresponding to the user identification information and determines the selected candidate user routine information as the user routine information. When the user identification information is not obtained, the server 420 or the home appliance 100 determines, as the user routine information, the candidate user routine information 1020 for which the user is not designated.

According to an embodiment of the disclosure, the user identification information may be included in one of the pieces of additional information described above with reference to FIGS. 10, 11, and 12. The user identification information may be collected as training data. In addition, the candidate user routine information may be learned by the machine learning model 810 by using the user identification information as the additional information. In addition, the user identification information may be input to the machine learning model 810 as the additional information, and the user routine information 1220 corresponding to the user identification information may be obtained from the machine learning model 810.

According to an embodiment of the disclosure, the user routine information corresponding to the user identification information may be input through the GUI of the external device 410, as described above with reference to FIG. 13. The external device 410 may receive the user identification information and the user routine information corresponding to the user identification information through the program or the application. The external device 410 transmits the received user identification information and user routine information to the server 420. The server 420 registers and stores the user routine information corresponding to the user identification information as the candidate user routine information, based on the information received from the external device 410.

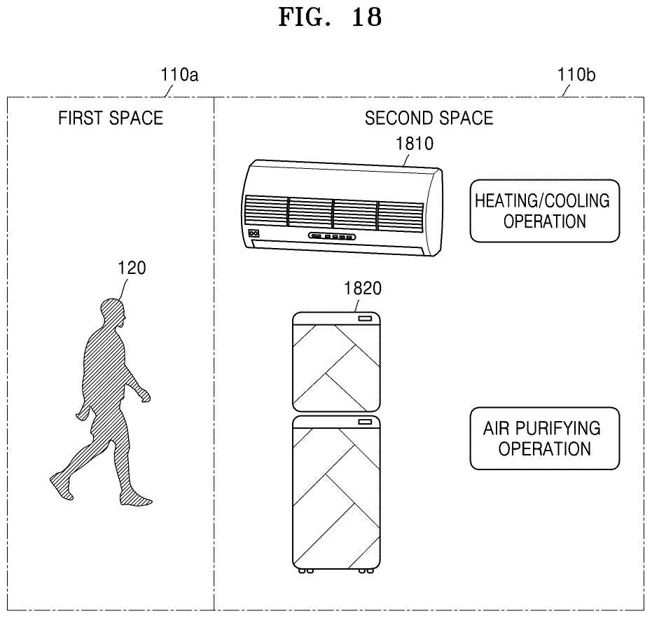

FIG. 18 is a diagram illustrating controlling home appliances of a second space, according to an embodiment of the disclosure.

Referring to FIG. 18, the following description is given on the assumption that a user 120 is detected in a first space 110a and a second space 110b is determined as a space predicted to be used next. According to an embodiment of the disclosure, the home appliance 100 to be controlled in the second space 110b may correspond to an air conditioner. For example, the air conditioner to be controlled in the second space may correspond to an air conditioner 1810, an air purifier 1820, a ventilation fan, a heater, or a dehumidifier. The air conditioner controls the air environment of the target space by controlling the temperature and air quality of the target space. However, the air conditioning operation takes a certain time to reach the target temperature or air condition. Therefore, when the user enters the space and operates the air conditioner, the space may not reach the desired air environment for a certain time after the user enters the space.

According to an embodiment of the disclosure, the server 420 or the home appliance 100 may control the air conditioner 1810 or the air purifier 1820 to start operating a certain time before the time when the user 120 is predicted to move from the first space 110a to the second space 110b, such that the desired air environment may be provided when the user 120 enters the second space 110b. The certain time may be defined from the time point when the usage time of the first space 110a is predicted to be completed. According to an embodiment of the disclosure, the certain time may correspond to the predicted time required for the air conditioning operation of the second space 110b. According to an embodiment of the disclosure, the server 420 or the home appliance 100 may start the cooling or heating operation of the air conditioner 1810 of the second space 110b in advance, such that the temperature of the second space 110b may be adjusted to the target temperature before the user 120 enters the second space 110b. In addition, according to an embodiment of the disclosure, the server 420 or the home appliance 100 may start the air purifying operation of the air purifier 1820 of the second space 110b in advance, such that the air condition of the second space 110b may be improved before the user 120 enters the second space 110b.

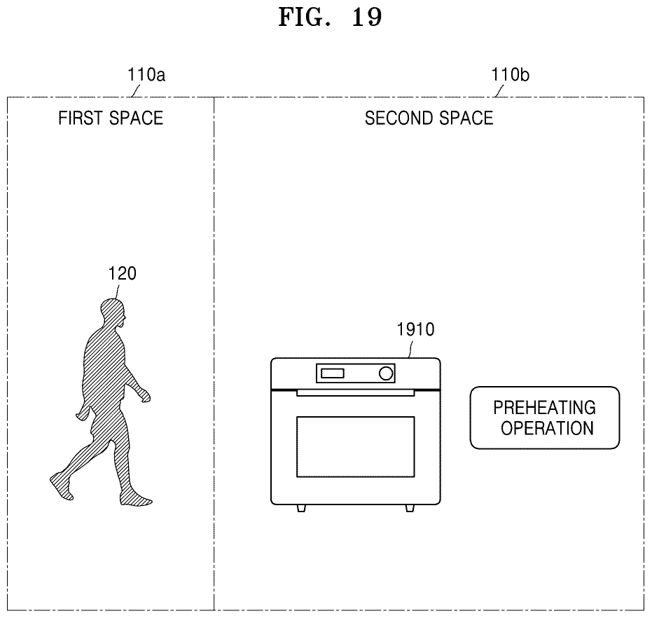

FIG. 19 is a diagram illustrating controlling home appliances of a second space, according to an embodiment of the disclosure.

Referring to FIG. 19, the following description is given on the assumption that a user 120 is detected in a first space 110a and a second space 110b is determined as a space predicted to be used next. According to an embodiment of the disclosure, the home appliance 100 to be controlled in the second space 110b may correspond to a cooking appliance 1910. The cooking appliance 1910 may include, for example, an oven, a cooker, an induction stove, a coffee maker, a capsule coffee machine, or an electric kettle. When the cooking appliance 1910 requires preheating, it takes time to preheat the cooking appliance 1910. Therefore, when the user 120 enters the second space 110b and operates the cooking appliance 1910, a waiting time occurs until the cooking appliance 1910 reaches a target temperature. In addition, when the temperature is controlled automatically, such as an oven, a cooker, a coffee maker, or an electric kettle, there is no major safety problem even when preheating or heating is performed before the user's operation.

According to an embodiment of the disclosure, the server 420 or the home appliance 100 may control the cooking appliance 1910 to start operating a certain time before the time when the user 120 is predicted to move from the first space 110a to the second space 110b, such that the cooking appliance 1910 has been preheated when the user 120 enters the second space 110b. As a result, according to an embodiment of the disclosure, the server 420 or the home appliance 100 has a significant effect of reducing the waiting time of the user 120 for preheating the cooking appliance 1910.

The certain time may be defined from the time point when the usage time of the first space 110a is predicted to be completed. According to an embodiment of the disclosure, the certain time may be determined according to the time predicted to be required to preheat the cooking appliance 1910.

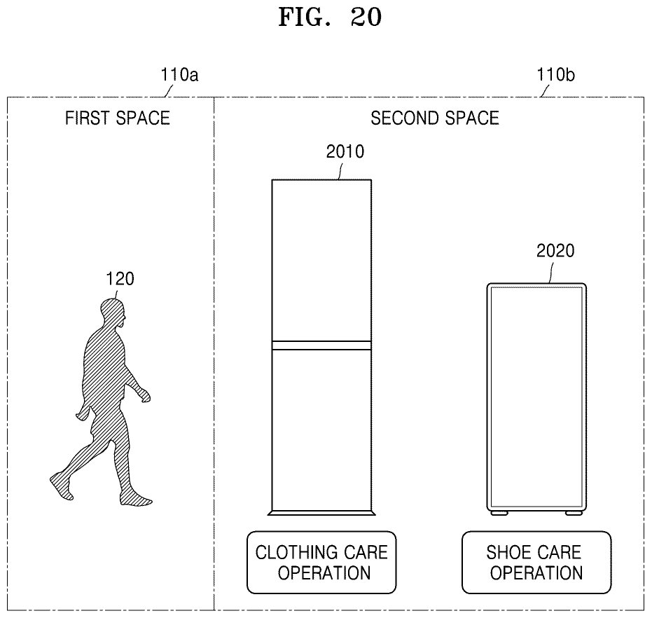

FIG. 20 is a diagram illustrating controlling home appliances of a second space, according to an embodiment of the disclosure.

Referring to FIG. 20, the following description is given on the assumption that a user 120 is detected in a first space 110a and a second space 110b is determined as a space predicted to be used next. According to an embodiment of the disclosure, the home appliance 100 to be controlled in the second space 110b may correspond to a clothing care device 2010 or a shoe care device 2020. The clothing care device 2010 and the shoe care device 2020 spray steam on clothes or shoes for a certain time and perform hot air drying. The steam spraying and hot air drying operation takes a certain time. Because the clothing care operation of the clothing care device 2010 and the shoe care operation of the shoe care device 2020 are automatically controlled, there is no major safety problem even when the operation is automatically started without the user 120 around.

According to an embodiment of the disclosure, the server 420 or the home appliance 100 may control the clothing care device 2010 or the shoe care device 2020 to start operating a certain time before the time when the user 120 is predicted to move from the first space 110a to the second space 110b, such that the clothing care operation or the shoe care operation is controlled to be in progress or completed when the user 120 enters the second space 110b. As a result, according to an embodiment of the disclosure, the server 420 or the home appliance 100 has a significant effect of reducing the waiting time of the user 120 for the clothing care operation or the shoe care operation.

The certain time may be defined from the time point when the usage time of the first space 110a is predicted to be completed. According to an embodiment of the disclosure, the certain time may be determined according to the time predicted to be required for the clothing care operation or the shoe care operation.

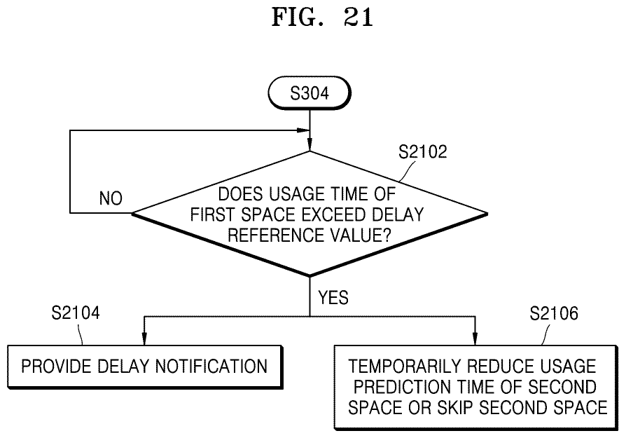

FIG. 21 is a diagram illustrating an operation when a user's usage time of a given space exceeds a usage prediction time, according to an embodiment of the disclosure.

According to an embodiment of the disclosure, referring to FIG. 21, when the user uses the space beyond the usage prediction time in the given space while detecting the spatial movement of the user based on user routine information, the server 420 or home appliance 100 provides notifications to users or temporarily changes user routine information. The server 420 or the home appliance 100 may increase user convenience by guiding the user such that his or her actions are not delayed when the user deviates from the user routine information and his or her movement is delayed.

In operation S2102, when it is determined in operation S304 that the user is using the first space, the server 420 or the home appliance 100 determines whether the usage time of the first space exceeds a delay reference value. The delay reference value is a value defined for each space and is determined based on the usage prediction time of the user routine information. For example, the delay reference value is determined as a value obtained by multiplying the usage prediction time by a second reference ratio. The second reference ratio may be, for example, a value between 1 and 2. In the example illustrated in FIG. 21, it is assumed that the first space is a dressing room, the usage prediction time is 10 minutes, and the delay reference value is 15 minutes. When the usage time of the user in the dressing room exceeds 15 minutes, the server 420 or the home appliance 100 determines that the usage time of the first space exceeds the delay reference value.

According to an embodiment of the disclosure, the delay time may be calculated from the start time of the routine. For example, the following description is given on the assumption that the user routine information illustrated in FIG. 8 is used and the usage time in the dressing room is 15 minutes. When the user spends 3 minutes in the bedroom, spends 4 minutes in the bathroom, and spends 15 minutes in the dressing room, the delay in the dressing room is 5 minutes, but 1 minute is shortened in the bedroom and 2 minutes are shortened in the bathroom. Accordingly, the total delay from the start time of the routine is 2 minutes. In this case, the server 420 or the home appliance 100 may calculate the delay time as 2 minutes. According to an embodiment of the disclosure, the server 420 or the home appliance 100 may determine that the delay has occurred when the delay time from the start time of the routine reaches the delay reference value of the dressing room. In the example described above, because 3 minutes are shortened from the routine before the dressing room and the reference delay value for the dressing room is 15 minutes, it is determined that the usage time of the dressing room has exceeded the delay reference value when the usage time of the dressing room reaches 18 minutes.

According to an embodiment of the disclosure, in operation S1204, when it is determined in operation S2102 that the usage time of the first space exceeds the delay reference value, the server 420 or the home appliance 100 outputs a delay notification indicating that the routine of the user is delayed through the home appliance 100 or the external device 410. For example, in operation S2104, a smartphone, a wearable device, or a wall pad corresponding to the external device 410 may output a notification indicating that the current route of the user is more than 5 minutes behind the routine of the user in the dressing room. According to an embodiment of the disclosure, in operation S2104, the home appliance 100 may output a notification through a speaker or a display that the current route of the user is more than 5 minutes behind the routine of the user in the dressing room.

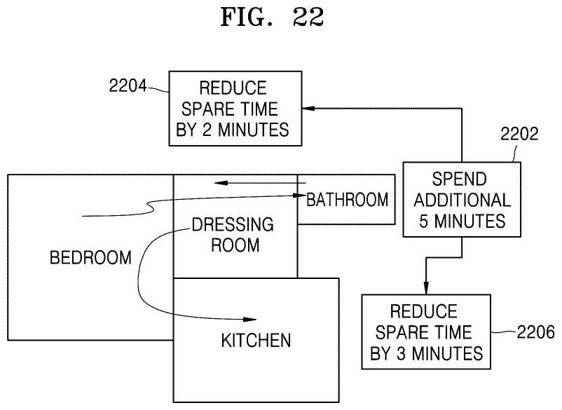

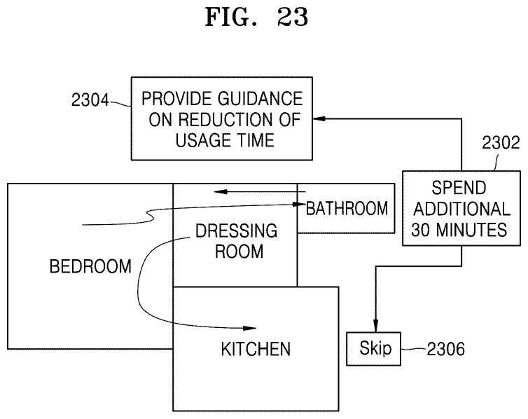

According to an embodiment of the disclosure, in operation S2106, when it is determined in operation S2102 that the usage time of the first space exceeds the delay reference value, the server 420 or the home appliance 100 may temporarily reduce the usage prediction time of the second space or skip the second space. Operation S2104 is described in more detail below with reference to FIGS. 22 and 23.

FIG. 22 is a diagram illustrating a process of temporarily reducing the usage prediction time in user routine information when a delay occurs in a user routine, according to an embodiment of the disclosure.

According to an embodiment of the disclosure, referring to FIG. 22, when a delay occurs in a user routine, the usage prediction time of some spaces in the user routine information may be temporarily reduced. The following description is given on the assumption that the spatial movement prediction path of the user routine information is defined in the order of a bedroom, a bathroom, a dressing room, and a kitchen, as illustrated in FIG. 22. According to an embodiment of the disclosure, when the user spends additional 5 minutes in the bathroom than the usage prediction time at block 2202, the server 420 or the home appliance 100 may temporarily reduce the usage prediction time of the dressing room or the kitchen, which is the path after the bathroom. For example, the server 420 or the home appliance 100 may reduce the usage prediction time of the dressing room by 2 minutes at block 2204 and may reduce the usage prediction time of the kitchen by 3 minutes at block 2206. The temporary reduction of the usage prediction time applies only to the user routine. When the user routine is restarted afterward, the server 420 or the home appliance 100 uses existing user routine information to which no temporary reduction has been applied.

According to an embodiment of the disclosure, the target space for reducing the usage prediction time may be determined according to priority. The priority may be predefined in the user routine information.

In addition, according to an embodiment of the disclosure, the reduction time of the usage prediction time that is temporarily reduced may be determined according to the priority of each space. The server 420 or the home appliance 100 may reduce the usage prediction time for a low-priority space to a greater extent than for a high-priority space.

In addition, according to an embodiment of the disclosure, the reduction time of the usage prediction time may be determined by the ratio of the usage prediction times of the respective spaces after the space in which the delay has occurred (e.g., the bathroom). For example, when the delay of 5 minutes occurs in the bathroom, the usage prediction time of the dressing room is 8 minutes, and the usage prediction time of the kitchen is 12 minutes, the ratio of the usage prediction time of the dressing room to the usage prediction time of the kitchen is 2:3. In this case, the server 420 or the home appliance 100 may reduce the usage prediction time of the dressing room by 2 minutes and the usage prediction time of the kitchen by 3 minutes, such that the ratio of the reduction time between the usage prediction time of the dressing room and the usage reduction time of the kitchen is also 2:3.

FIG. 23 is a diagram illustrating a process of omitting some space from user routine information when a delay occurs in a user routine, according to an embodiment of the disclosure.

According to an embodiment of the disclosure, referring to FIG. 23, when a delay occurs in a user routine, the server 420 or the home appliance 100 may guide to omit some spaces of the user routine information. The following description is given on the assumption that the spatial movement prediction path of the user routine information is defined in the order of a bedroom, a bathroom, a dressing room, and a kitchen, as illustrated in FIG. 23. According to an embodiment of the disclosure, when the user spends additional 30 minutes in the bathroom than the usage prediction time at block 2302, the server 420 or the home appliance 100 may temporarily omit at least one of the dressing room or the kitchen, which is the path after the bathroom. For example, the server 420 or the home appliance 100 may provide the user with guidance on the reduction of the usage time so as to reduce the usage time of the dressing room as much as possible at block 2304. The server 420 or the home appliance 100 may output a guide requesting to reduce the usage time of the dressing room through the external device 410 or the home appliance 100. In addition, the server 420 or the home appliance 100 may guide the user to skip the kitchen, which is the route after the dressing room at block 2306.

The temporary omission of some paths applies only to the user routine. When the user routine is restarted afterward, the server 420 omitted the home appliance 100 uses existing user routine information to which no temporary omission has been applied.

According to an embodiment of the disclosure, the target space to be omitted in the user routine may be determined according to priority. The priority may be predefined in the user routine information.

According to an embodiment of the disclosure, the server 420 or the home appliance 100 may determine whether to reduce the usage prediction time of some spaces in the user routine or to omit some spaces in the user routine, depending on the delay time. For example, when a delay time in a certain space is less than an omission reference value, the server 420 or the home appliance 100 reduces the usage prediction time of some spaces without omitting the space. When the delay time in the certain space is greater than the omission reference value, the server 420 or the home appliance 100 omits some spaces in the user routine.

According to an embodiment of the disclosure, the user may set the target end time of the user routine, and the server 420 or the home appliance 100 may determine user routine information according to the target end time. For example, when the user sets a target commute time to 7 a.m., the server 420 or the home appliance 100 determines user routine information such that the user routine ends at 7 a.m. The server 420 or the home appliance 100 compares the start time of the user routine with the target end time. When the remaining time until the target end time is less than the total time of the user routine information, the server 420 or the home appliance 100 may temporarily reduce the usage prediction time of the user routine information.

In addition, according to an embodiment of the disclosure, the server 420 or the home appliance 100 may provide the user routine progress information of the user through the external device 410. The user routine progress may indicate the path on which the routine has been completed and the path scheduled to progress. In addition, the user routine progress may indicate the time spent on each path. In addition, the user routine progress may indicate the usage prediction time of the remaining path. Furthermore, when the target end time is set, the user routine progress may indicate the time remaining until the target end time.

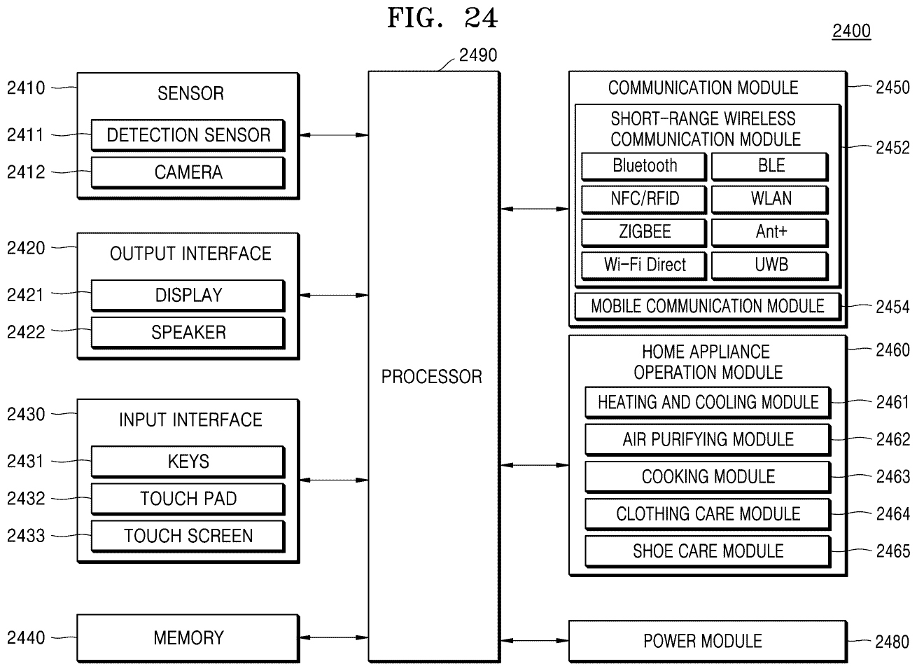

FIG. 24 is a diagram illustrating a structure of a home appliance according to an embodiment of the disclosure.

Referring to FIG. 24, a home appliance 2400 may include a sensor 2410, an output interface 2420, an input interface 2430, memory 2440, a communication module 2450, a home appliance operation module 2460, a power module 2480, and a processor 2490. The home appliance 2400 may include various combinations of the components illustrated in FIG. 24, and not all of the components illustrated in FIG. 24 are essential.

The home appliance 2400 of FIG. 24 corresponds to the home appliance 100 described with reference to FIG. 2. The memory 2440 corresponds to the memory 214 described with reference to FIG. 2. The communication module 2450 corresponds to the communication module 220 described with reference to FIG. 2. The processor 2490 corresponds to the processor 210 described with reference to FIG. 2. The detection sensor 2411 corresponds to the detection sensor 230 described with reference to FIG. 2. The camera 2412 corresponds to the camera 1710 described with reference to FIG. 17.

The sensor 2410 may include various types of sensors, for example, the detection sensor 2411 and the camera 2412.

The output interface 2420 may include at least one of a display 2421 or a speaker 2422, or may include any combination thereof. The output interface 2420 outputs various notifications, messages, information, or the like, which is generated by the processor 2490.

The input interface 2430 may include keys 2431, a touch pad 2432, and a touch screen 2433. The input interface 2430 may receive user input and transmit the received user input to the processor 2490.

The memory 2440 may store a variety of information, data, instructions, programs, and the like, which are necessary for the operation of the home appliance 2400. The memory 2440 may include at least one of volatile memory or non-volatile memory, or may include any combination thereof. The memory 2440 may include, for example, at least one type of storage medium selected from flash memory-type memory, hard disk-type memory, multimedia card micro-type memory, card-type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, magnetic disc, and optical disc. In addition, the home appliance 2400 may operate a web storage or a cloud server that performs a storage function on the Internet.

The communication module 2450 may include at least one to the discharge side of a short-range wireless communication module 2452 or a long-range communication module 2454, or a combination thereof. The communication module 2450 may include at least one antenna that wirelessly communicates with other devices.

The short-range wireless communication module may include a Bluetooth communication module, a BLE communication module, an NFC communication interface, a WLAN (Wi-Fi™) communication module, a ZigBee communication module, an IrDA communication module, a WFD communication module, a UWB communication module, an Ant+ communication module, and the like, but the disclosure is not limited thereto.

The mobile communication module 2454 transmits and receives radio signals to and from at least one of a base station, an external terminal, or a server on a mobile communication network. The radio signals may include voice call signals, video call signals, or various types of data according to text/multimedia message transmission and reception.

The home appliance operation module 2460 includes a heating and cooling module 2461, an air purifying module 2462, a cooking module 2463, a clothing care module 2464, and a shoe care module 2465. Depending on the type of home appliance 2400, an operation module corresponding to the home appliance operation module 2460 is included.

The power module 2480 supplies power to the home appliance 2400. The power module 2480 includes a battery, a power driving circuit, a converter, a transformer circuit, and the like. The power module 2480 is connected to an external power source to receive power.

The processor 2490 controls overall operations of the home appliance 2400. The processor 2490 may execute the program stored in the memory 2440 to control the elements of the home appliance 2400.

According to an embodiment of the disclosure, the processor 2490 may include a separate neural processing unit (NPU) that performs an operation of a machine learning model. In addition, the processor 2490 may include a CPU, a graphics processing unit (GPU), and the like.

The processor 2490 may perform operations such as operation mode control of the home appliance 2400, driving path determination and control, obstacle recognition, cleaning operation control, location recognition, communication with an external server, remaining battery capacity monitoring, and battery charging operation control.

A machine-readable storage medium may be provided in the form of a non-transitory storage medium. The non-transitory storage medium is a tangible device and only means not including a signal (e.g., electromagnetic wave). This term does not distinguish between a case where data is semi-permanently stored in a storage medium and a case where data is temporarily stored in a storage medium. For example, the non-transitory storage medium may include a buffer in which data is temporarily stored.

According to an embodiment, the methods according to various embodiments of the disclosure may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

According to an embodiment of the disclosure, a home appliance control method is provided. The home appliance control method includes, when a user is detected in a first space among a plurality of spaces within a home, determining whether the user is using the first space, based on a first usage time for which the user stays in the first space. In addition, the home appliance control method includes, when it is determined that the detected user is using the first space, determining a second space predicted to be used next by the user among the plurality of spaces within the home, based on user routine information including a spatial movement prediction path of the user predicted in advance for the plurality of spaces within the home. Furthermore, the home appliance control method includes controlling an operation of at least one home appliance of the second space.

In addition, according to an embodiment of the disclosure, the determining of whether the user is using the first space may include, when the first usage time is greater than or equal to a first reference time, determining that the user is using the first space.

In addition, according to an embodiment of the disclosure, the first reference time may be a value obtained by multiplying a usage prediction time of the first space included in the machine-learned user routine information by a first reference ratio, and the first reference ratio may be a value between 0.5 and 1.

In addition, according to an embodiment of the disclosure, the user routine information may be information that is machine-learned by using training data including the usage time of the user and space usage order for the plurality of spaces within the home.

In addition, according to an embodiment of the disclosure, the user routine information may include a spatial movement order and usage prediction time information for each space with respect to for the plurality of spaces within the home.

In addition, according to an embodiment of the disclosure, the user routine information may be defined according to at least one of weather, season, or day of week.

In addition, according to an embodiment of the disclosure, the determining of whether the user is using the first space may include, when a wake-up event in which the user wakes up is detected, counting the first usage time of the user in the first space.

In addition, according to an embodiment of the disclosure, the home appliance control method may further include detecting the wake-up event based on at least one of wake-up alarm information of the user, a sensor detection value of a sensor arranged in a bed of the user, or a sensor detection value of a detection sensor of a home appliance arranged in the first space.

In addition, according to an embodiment of the disclosure, the spatial movement prediction path of the user may correspond to a prediction path between two or more spaces including the first space and the second space, the first space may correspond to a current space in which the user is currently detected, the second space may correspond to a space predicted to be used after the current space, and the determining of the second space may be stopped when the user deviates from the spatial movement prediction path of the user routine information.

In addition, according to an embodiment of the disclosure, the home appliance control method may further include detecting a user in the first space by using a sensor detection value of a detection sensor of a home appliance arranged in the first space.

In addition, according to an embodiment of the disclosure, the home appliance control method may further include identifying the user by using a detection value of a wearable device worn by the user, wherein the determining of the second space may include determining the second space based on the user routine information for the identified user.

In addition, according to an embodiment of the disclosure, the home appliance control method may further include identifying the user by using an image captured by a first camera arranged in the first space, wherein the determining of the second space may include determining the second space based on the user routine information for the identified user.

In addition, according to an embodiment of the disclosure, the at least one home appliance may include an air conditioner.

In addition, according to an embodiment of the disclosure, the at least one home appliance may include a cooking appliance.

In addition, according to an embodiment of the disclosure, the at least one home appliance may include at least one of a clothing care device or a shoe care device.

In addition, according to an embodiment of the disclosure, the home appliance control method may further include, when the first usage time is greater than or equal to a delay reference value, providing a notification to the user that the user routine has been delayed, wherein the delay reference value may be a value obtained by multiplying the usage prediction time of the first space by a second reference ratio, and the second reference ratio may be a value between 1 and 2.

In addition, according to an embodiment of the disclosure, the home appliance control method may further include, when the first usage time is greater than or equal to the delay reference value, temporarily reducing a second usage prediction time for which the user defined in the user routine information is predicted to stay in the second space.

In addition, according to an embodiment of the disclosure, a home appliance is provided. The home appliance includes a communication module 220 configured to communicate with at least one home appliance arranged in a plurality of spaces within a home. In addition, the home appliance includes a detection sensor 230 configured to detect a user in a space within the home. In addition, the home appliance includes memory 214 storing at least one instruction. Furthermore, the home appliance includes at least one processor 210. The at least one processor 210 is configured to execute the at least one instruction to, when a user is detected in a first space among the plurality of spaces within the home by using a sensor detection value of the detection sensor 230, determine whether the user is using the first space, based on a first usage time for which the user stays in the first space, when it is determined that the detected user is using the first space, determine a second space predicted to be used next by the user among the plurality of spaces within the home, based on user routine information including a spatial movement prediction path of the user predicted in advance for the plurality of spaces within the home, and controlling an operation of at least one home appliance of the second space.

In addition, according to an embodiment of the disclosure, the home appliance 100 may correspond to at least one of a home appliance arranged in the first space or a home appliance arranged in the second space.

Furthermore, according to an embodiment of the disclosure, provided is a computer-readable recording medium having recorded thereon a program for causing a computer to perform the home appliance control method.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A home appliance control method comprising:
when a user is detected in a first space among a plurality of spaces within a home, determining whether the user is using the first space, based on a first usage time for which the user stays in the first space;
when it is determined that the detected user is using the first space, determining a second space predicted to be used next by the user among the plurality of spaces within the home, based on user routine information including a spatial movement prediction path of the user predicted in advance for the plurality of spaces within the home; and
controlling an operation of at least one home appliance of the second space.

2. The home appliance control method of claim 1, wherein the determining of whether the user is using the first space comprises, when the first usage time is greater than or equal to a first reference time, determining that the user is using the first space.

3. The home appliance control method of claim 2, wherein the first reference time is a value obtained by multiplying a usage prediction time of the first space included in the user routine information by a first reference ratio, and the first reference ratio is a value between 0.5 and 1.

4. The home appliance control method of claim 1, wherein the user routine information is information that is machine-learned by using training data including the usage time of the user and space usage order for the plurality of spaces within the home.

5. The home appliance control method of claim 1, wherein the user routine information includes a spatial movement order and usage prediction time information for each space with respect to for the plurality of spaces within the home.

6. The home appliance control method of claim 1, wherein the user routine information is defined according to at least one of weather, season, or day of week.

7. The home appliance control method of claim 1, wherein the determining of whether the user is using the first space comprises, when a wake-up event in which the user wakes up is detected, counting the first usage time of the user in the first space.

8. The home appliance control method of claim 7, further comprising:
detecting the wake-up event based on at least one of wake-up alarm information of the user, a sensor detection value of a sensor arranged in a bed of the user, or a sensor detection value of a detection sensor of a home appliance arranged in the first space.

9. The home appliance control method of claim 1,
wherein the spatial movement prediction path of the user corresponds to a prediction path between two or more spaces including the first space and the second space,
wherein the first space corresponds to a current space in which the user is currently detected, and the second space corresponds to a space predicted to be used after the current space, and
wherein the determining of the second space is stopped when the user deviates from the spatial movement prediction path of the user routine information.

10. The home appliance control method of claim 1, further comprising:
detecting a user in the first space by using a sensor detection value of a detection sensor of a home appliance arranged in the first space.

11. The home appliance control method of claim 1, further comprising:
identifying the user by using a detection value of a wearable device worn by the user,
wherein the determining of the second space comprises determining the second space based on the user routine information for the identified user.

12. The home appliance control method of claim 1, further comprising:
identifying the user by using an image captured by a first camera arranged in the first space,
wherein the determining of the second space comprises determining the second space based on the user routine information for the identified user.

13. The home appliance control method of claim 1, wherein the at least one home appliance comprises an air conditioner.

14. The home appliance control method of claim 1, wherein the at least one home appliance comprises a cooking appliance.

15. The home appliance control method of claim 1, wherein the at least one home appliance comprises at least one of a clothing care device or a shoe care device.

16. The home appliance control method of claim 1, further comprising:
when the first usage time is greater than or equal to a delay reference value, providing a notification to the user that the user routine has been delayed; and
when the first usage time is greater than or equal to the delay reference value, temporarily reducing a second usage prediction time for which the user defined in the user routine information is predicted to stay in the second space,
wherein the delay reference value is a value obtained by multiplying the usage prediction time of the first space by a second reference ratio, and the second reference ratio is a value between 1 and 2.

17. The home appliance control method of claim 1, further comprising:
storing the at least one home appliance of the second space which is matched with the second space.

18. A home appliance comprising:
communication module configured to communicate with at least one home appliance arranged in a plurality of spaces within a home;
a detection sensor configured to detect a user in a space within the home;
memory storing at least one instruction; and
at least one processor,
wherein the at least one processor is configured to execute the at least one instruction to:
when a user is detected in a first space among the plurality of spaces within the home by using a sensor detection value of the detection sensor, determine whether the user is using the first space, based on a first usage time for which the user stays in the first space,
when it is determined that the detected user is using the first space, determine a second space predicted to be used next by the user among the plurality of spaces within the home, based on user routine information including a spatial movement prediction path of the user predicted in advance for the plurality of spaces within the home, and
control an operation of at least one home appliance of the second space.

19. The home appliance of claim 18, wherein the home appliance corresponds to at least one of a home appliance arranged in the first space or a home appliance arranged in the second space.

20. A computer-readable recording medium storing one or more computer programs including computer-executable instructions that, when executed by one or more processors of home appliance individually or collectively, cause the home appliance to perform operations, the operations comprising:
when a user is detected in a first space among a plurality of spaces within a home, determining whether the user is using the first space, based on a first usage time for which the user stays in the first space;
when it is determined that the detected user is using the first space, determining a second space predicted to be used next by the user among the plurality of spaces within the home, based on user routine information including a spatial movement prediction path of the user predicted in advance for the plurality of spaces within the home; and
controlling an operation of at least one home appliance of the second space.
